(19) United States
(12) Patent Application Publication
(10) Pub. No.: US 2021/0272293 A1
(43) Pub. Date: Sep. 2, 2021

(54) IMAGE PROCESSING DEVICE AND IMAGE PROCESSING METHOD

(71) Applicant: SONY CORPORATION, TOKYO (JP)

(72) Inventors: NORIAKI OOISHI, KANAGAWA (JP); ATSUMASA OSAWA, KANAGAWA (JP)

(21) Appl. No.: 17/250,235

(22) PCT Filed: Jun. 14, 2019
(86) PCT No.: PCT/JP2019/023689

§ 371 Date: Dec. 21, 2020

(30) Foreign Application Priority Data
Jun. 28, 2018 (JP) 2018-122602

(51) Int. Cl. G06T 7/215; G06T 7/11; G06K 9/32; G06K 9/46; G06T 7/246

(52) U.S. Cl. CPC G06T 7/215; G06T 7/11; G06T 7/246; G06K 9/46; G06K 9/3233

(57) ABSTRACT

The present disclosure relates to an image processing device and an image processing method capable of suppressing a reduction in image quality. A partial region at a position in response to a motion of a region of interest within an image to date is segmented from the image, an image of the partial region segmented from the image is coded, and coded data is generated. For example, a position moved from a central position of the current region of interest in the same direction by the same distance as a direction and a distance of the motion of the region of interest to date is set as a central position of the partial region. The present disclosure is applicable to, for example, an image processing device, an image coding device, or an image decoding device.

### TECHNICAL FIELD

The present disclosure relates to an image processing device and an image processing method, and particularly relates to an image processing device and an image processing method capable of suppressing a reduction in image quality.

### BACKGROUND ART

Conventionally, a product that functions to output an image of not a subject at a full angle of view but only a segmented partial region of the subject is known in the image sensor field (refer to, for example, PTL 1). Using such a product makes it possible to realize a system that segments only a region of interest (ROI) from an image captured by a camera and that codes, transmits, and records the segmented ROI.

In a case of coding the image of the segmented ROI region itself in such a system, an image quality of the image degrades when there is a motion in a surrounding boundary part of the region. This is due to discontinuity of the boundary of the ROI for coding processing (incapability of using a region outside of the boundary for motion prediction), which causes a reduction in. coding efficiency in the surrounding part.

To address the problem, it has been considered to set an image obtained by segmenting not only the ROI but also a region in a fixed frame surrounding the ROI as an object to be coded. In this case, the discontinuity is mitigated by addition of the region in the fixed frame to the surroundings of the ROI, and the image quality is thereby improved even with the motion in the surrounding boundary part of the ROI.

### CITATION LIST

### Patent Literature

### [PTL 1]

Japanese Patent Laid-Open No. 2009-49979

### SUMMARY

### Technical Problem

However, in a case of a motion beyond the region in the fixed frame in the ROI (more properly, in an intended object within the ROI or a background thereof), then motion prediction is unsuccessful, possibly resulting in degradation of the image quality.

The present disclosure has been achieved in light of such circumstances, and an object of the present disclosure is to enable suppression of a reduction in image quality.

### Solution to Problem

An image processing device according to one aspect of the present technology is an image processing device including a segmentation section that segments a partial region at a position in response to a motion of a region of interest within an image to date from the image, and a coding section that codes an image of the partial region segmented from the image by the segmentation section, and that generates coded data.

An image processing method according to one aspect of the present technology is an image processing method including segmenting a partial region at a position in response to a motion of a region of interest within an image to date from the image, and coding an image of the partial area segmented from the image and generating coded data.

An image processing device according to another aspect of the present technology is an image processing device including an extraction section that extracts, from coded data that contains region-of-interest separation information for separating a region of interest from an image, the region-of-interest separation information, a decoding section that decodes the coded data and that generates the image, and a separation section that separates the region of interest from the image generated by the decoding section on the basis of the region-of-interest separation information extracted by the extraction section.

An image processing method according to another aspect of the present technology is an image processing method including extracting, from coded data that contains region-of-interest separation information for separating a region of interest from an image, the region-of-interest separation information, decoding the coded data and generating the image, and separating the region of interest from the generated image on the basis of the extracted region-of-interest separation information.

In the image processing device and the image processing method according to one aspect of the present technology, a partial region at a position in response to a motion of a region of interest within an image to date is segmented from the image, an image of the partial region segmented from the image is coded, and coded data is generated.

In the image processing device and the image processing method according to another aspect of the present technology, region-of-interest separation information for separating a region of interest from an image is extracted from coded data that contains the region-of-interest separation information, the coded data is decoded and the image is generated, and the region of interest is separated from the generated image on the basis of the extracted region-of-interest separation information.

### Advantageous Effects of Invention

According to the present disclosure, it is possible to process an image. It is particularly possible to suppress a reduction in image quality. It is noted that advantages of the present disclosure are not always limited to those described above and the present disclosure may exhibit any of the advantages described in the present specification or other advantages that can be grasped from the present specification in addition to or as an alternative to the above advantages.

### BRIEF DESCRIPTION OF DRAWINGS

FIG. 1 is a block diagram depicting an example of principal configurations of an image coding device.

FIG. 2 is a diagram depicting an example of a state of setting of initial values and constraint conditions of ROI tracking and detection processing.

FIG. 3 is a diagram depicting an example of a state of setting initial values of a shape and a size of a segmented region.

FIG. 4 is a flowchart illustrating an example of a flow of image coding processing.

FIG. 5 is a flowchart illustrating an example of a flow of segmented region setting processing.

FIG. 6 is a diagram illustrating an example of a segmented region.

FIG. 7 is a diagram illustrating an example of a segmented region.

FIG. 8 is a diagram illustrating an example of a segmented region.

FIG. 9 is a diagram illustrating an example of a segmented region.

FIG. 10 is a diagram illustrating an example of a segmented region.

FIG. 11 is a block diagram depicting an example of principal configurations of an image coding device.

FIG. 12 is an explanatory diagram of an example of a state of setting an ROI motion estimation vector.

FIG. 13 is an explanatory diagram of an example of a state of setting an ROI motion estimation vector.

FIG. 14 is a flowchart illustrating an example of a flow of image coding processing.

FIG. 15 is a flowchart illustrating an example of a flow of segmented region setting processing.

FIG. 16 is a flowchart illustrating an example of a flow of segmented region setting processing.

FIG. 17 is a flowchart illustrating an example of a flow of segmented region setting processing.

FIG. 18 is a block diagram depicting an example of principal configurations of an image coding device.

FIG. 19 is a flowchart illustrating an example of a flow of image coding processing.

FIG. 20 is a block diagram depicting an example of principal configurations of an image decoding device.

FIG. 21 is a flowchart illustrating an example of a flow of image decoding processing.

FIG. 22 is an explanatory diagram of an example of ROI separation information.

FIG. 23 is a block diagram depicting an example of principal configurations of an image coding device.

FIG. 24 is a flowchart illustrating an example of a flow of image coding processing.

FIG. 25 is a diagram illustrating an example of a segmented region.

FIG. 26 is a block diagram depicting an example of principal configurations of an image coding device.

FIG. 27 is flowchart illustrating an example of a flow of image coding processing.

FIG. 28 is a block diagram depicting an example of principal configurations of an image decoding device.

FIG. 29 is a flowchart illustrating an example of a flow of image decoding processing.

FIG. 30 is a block diagram depicting an example of principal configurations of an image decoding device.

FIG. 31 is a flowchart illustrating an example of a flow of image decoding processing.

FIG. 32 is a block diagram depicting an example of principal configurations of a computer.

### DESCRIPTION OF EMBODIMENTS

Modes for carrying out the present disclosure (hereinafter, referred to as “embodiments”) will be described hereinafter. It is noted that the present disclosure will be described in the following order.
1. First embodiment (setting of segmented region based on ROI motion vector)
2. Second embodiment (setting of segmented region based on ROI motion estimation vector)
3. Third embodiment (setting of segmented region)
4. Fourth embodiment (signaling of ROI separation information)
5. Fifth embodiment (parallel coding of a plurality of ROIs)
6. Sixth embodiment (serial coding of a plurality of ROIs)
7. Seventh embodiment (parallel decoding of a plurality of ROIs)
8. Eighth embodiment (serial decoding of a plurality of ROIs)
9. Notes

### 1. First Embodiment

### <Image Coding Device>

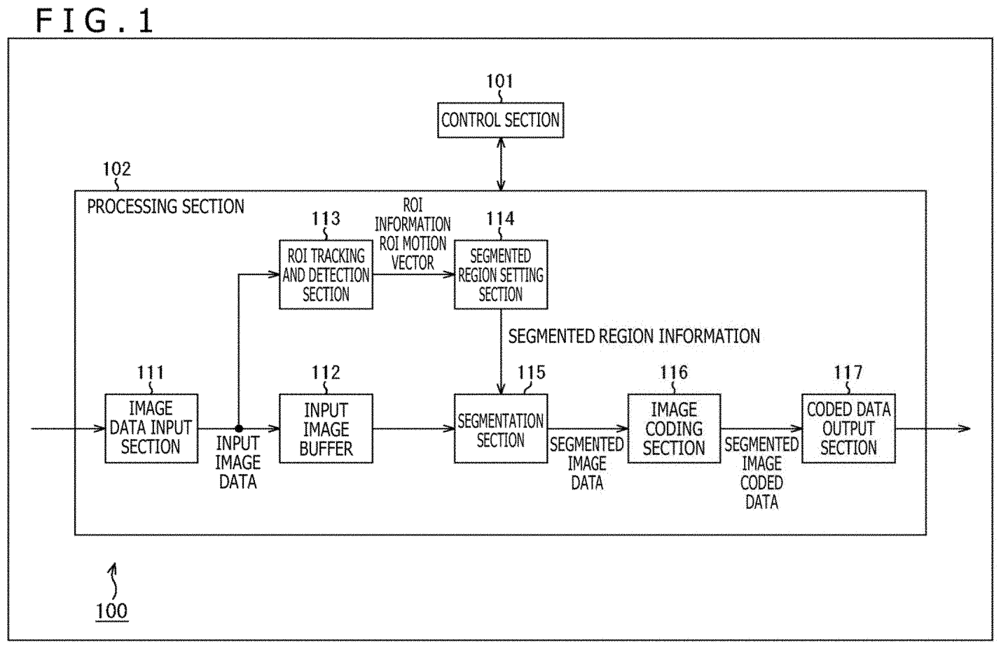

FIG. 1 is a block diagram depicting an example of configurations of an image coding device according to one aspect of an image processing device to which the present technology is applied. An image coding device 100 depicted in FIG. 1 is a device that codes a region of interest (ROI) within an image.

As depicted in FIG. 1, the image coding device 100 has a control section 101 and a processing section 102. The control section 101 has, for example, a CPU (Central Processing Unit), a ROM (Read Only Memory), a RAM (Random Access Memory), and the like, executes a predetermined program, and controls operations of the processing section 102. The processing section 102 performs processing associated with coding of an image under control of the control section 101.

As depicted in FIG. 1, the processing section 102 has an image data input section 111, an input image buffer 112, an ROT tracking and detection section 113, a segmented region setting section 114, a segmentation section 115, an image coding section 116, and a coded data output section 117.

The image data input section 111 imports image data (input image data) supplied from an outside, and supplies the image data to the input image buffer 112 and the ROI tracking and detection section 113.

The input image buffer 112 is a buffer intended to absorb a processing delay of the ROI tracking and detection section 113. The input image buffer 112 temporarily stores the input image data supplied from the image data input section 111, and supplies the input image data to the segmentation section 115 at appropriate timing (given timing).

The ROI tracking and detection section 113 performs ROI tracking and detection while referring to the input image data supplied from the image data input section 111, detects ROI information and an ROI motion vector, and supplies the ROI information and the ROI motion vector to the segmented region setting section 114.

It is noted that the “ROI information” indicates information associated with an ROI, and contains a shape (for example, rectangular shape), a size (for example, the number of vertical pixels and the number of horizontal pixels in the case of the rectangular shape), and position information (for example, center coordinates or offset coordinates in the case of the rectangular shape) of the region on an image coordinate system of the input image. Further, the “ROI motion vector information” indicates a motion vector of the overall ROI relative to the input image. In other words, the ROI information and the ROI motion vector indicate a motion of the ROI to date. In other words, the ROI tracking and detection section 113 obtains the motion of the ROI to date by tracking and detecting the ROI.

Moreover, a method of this ROI tracking and detection may be an optional method. For example, object detection technology and object tracking technology in computer vision may be used.

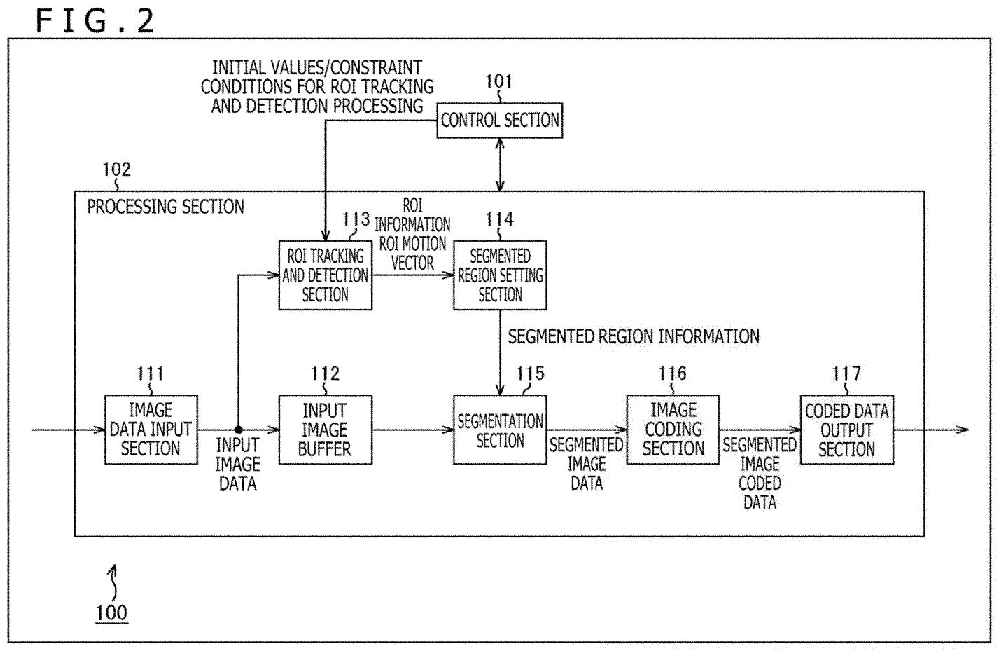

Furthermore, initial values (such as the initial values of the shape, the size, and the position information regarding the ROI) of ROI tracking and detection processing performed by the ROI tracking and detection section 113 may be set by, for example, the control section 101 as depicted in FIG. 2. For example, a user or the like may input information associated with the initial values, and the control section 101 may set the initial values to the ROI tracking and detection section 113 on the basis of the information. At that time, the user may confirm an overall input image by display means (such as a monitor) that is not depicted, and designate the initial values by input means (such as a keyboard or a mouse) that is not depicted. Further, constraint conditions of the ROI tracking and detection processing (such as a maximum shape and a maximum size of the ROI and a tracking range) may be similarly set by the control section 101. For example, the user or the like may input information associated with the constraint conditions, and the control section 101 may set the constraint condition to the ROI tracking and detection section 113 on the basis of the information.

The segmented region setting section 114 sets a segmented region that is a region to be segmented (extracted) from the input image.

An image of this segmented region (also referred to as “segmented image”) is an image possibly used in coding and decoding of an image of the ROI (also referred to as “ROI image”). Since an originally intended region (region to be coded) is the ROI, the image coding device 100 segments and codes only this segmented region without coding the overall input image.

This can reduce coding of unnecessary regions, and thus, it is possible to suppress an increase in a code amount (to reduce the code amount). If an intention is to obtain a decoded image of the ROI, it can be rephrased that it is possible to reduce a reduction in coding efficiency (to improve coding efficiency) for obtaining the decoded image of the same ROI. Moreover, this can suppress an increase in a load of coding and decoding (reduce a load) and suppress increases in cost, power consumption, processing time, and the like (reduce a cost, power consumption, processing time, and the like).

It is noted that “used in coding and decoding of the ROI image” includes herein used in not only inter prediction but also in inter prediction. In other words, the “used in coding and decoding of the ROI image” includes used in coding and decoding of the ROI image in a frame to he processed later.

The segmented region setting section 114 sets a position of this segmented region on the basis of the ROI information and the ROI motion vector supplied from the ROI tracking and detection section 113. In other words, the segmented region setting section 114 sets the position of this segmented region on the basis of the motion of the ROI to date.

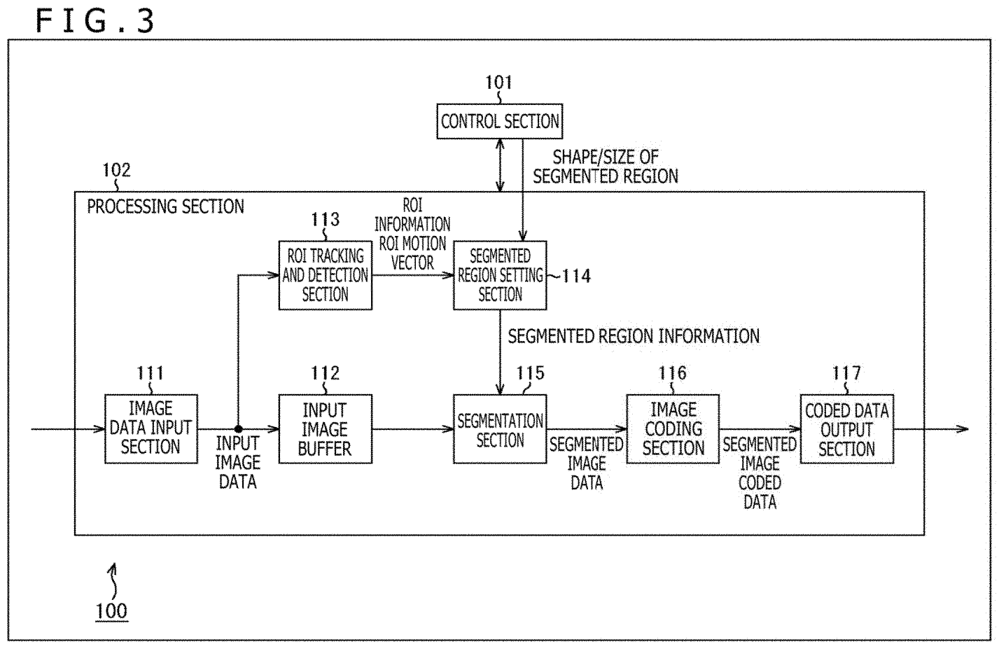

The segmented region setting section 114 also sets the shape and the size of the segmented region. For example, the segmented region setting section 114 sets the shape and the size of this segmented region to a preset predetermined shape and a preset predetermined size. The shape and the size of this segmented region may be set by the control section 101 as depicted in, for example, FIG. 3. For example, the user or the like may input information associated with the shape and the size of the segmented region, and the control section 101 may set the shape and the size of the segmented region to the segmented region on the basis of the information. At that time, the user may confirm the input image and the ROI by the display means (such as a monitor) that is not depicted, and designate the shape and the size of the segmented region by the input means (such as a keyboard or a mouse) that is not depicted.

The segmented region setting section 114 supplies these pieces of set information (such as the shape, the size, and the position) associated with the segmented region to the segmentation section 115 as segmented region information.

The segmentation section 115 segments, from the input image supplied from the input image buffer 112, a segmented region (segmented image) designated by the segmented region information supplied from the segmented region setting section 114. In other words, the segmentation section 115 segments, from the input image, a partial region at a position in response to the motion of the region of interest within the input image to date.

Additionally, the segmentation section 115 segments the partial region with the position in response to the motion of the ROI to date obtained by tracking and detecting the ROI by the ROI tracking and detection section 113 set as a central position of the partial region. Furthermore, the segmentation section 115 segments the segmented region at the preset shape and the preset size. The segmentation section 115 supplies image data regarding the segmented image (segmented image data) segmented in such a way to the image coding section 116.

The image coding section 116 codes the segmented image data supplied from the segmentation section 115 and generates coded data (segmented image coded data). In other words, the image coding section 116 codes the image (segmented image) of the partial region segmented from the input image by the segmentation section 115, and generates the coded data (segmented image coded data). It is noted that a method of this image coding may be an optional method. For example, image coding according to MPEG (Moving Picture Experts Group), AVC (Advanced Video Coding), HEVC (High Efficiency Video Coding), or the like may be used. The image coding section 116 supplies the generated segmented image coded data to the coded data output section 117.

The coded data output section 117 outputs the segmented image coded data supplied from the image coding section 116 to the outside.

Since the segmented image at the position in response to the motion of the ROI is segmented and coded as described above, the image coding device 100 can reduce a probability that the ROI deviates from the segmented region in consideration of the motion of the ROI. Therefore, it is possible to reduce a probability of unsuccessful motion prediction, and thus, it is possible to suppress a reduction in image quality of a decoded image (segmented image or ROI image).

### <Flow of Image Coding Processing>

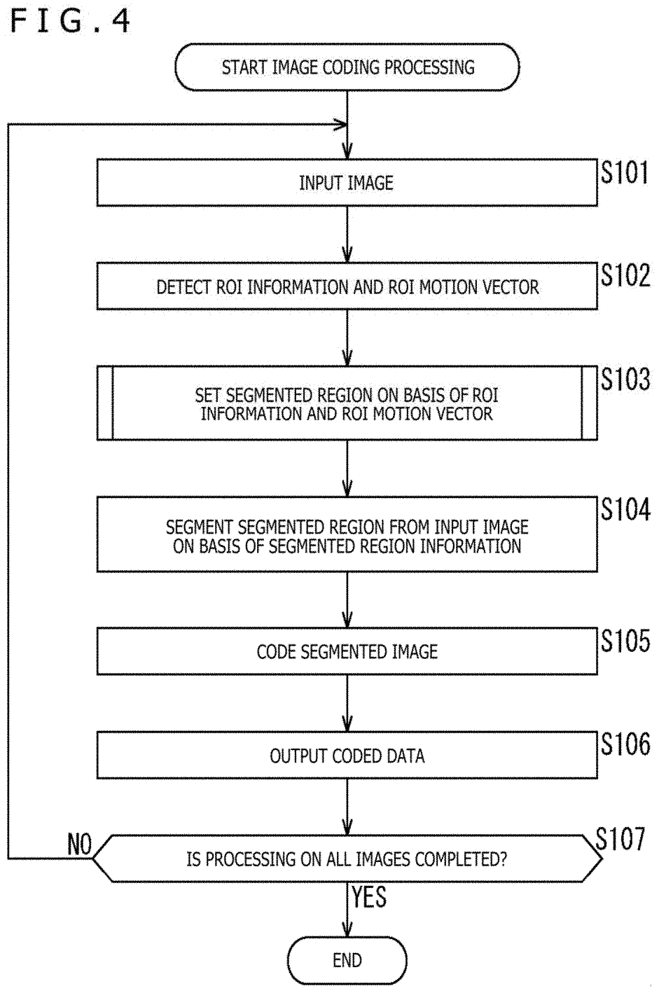

An example of a flow of image coding processing executed by the image coding device 100 will next be described with reference to a flowchart of FIG. 4.

When the image coding processing is started, the image data input section 111 receives an image input from the outside in Step S101. The input image buffer 112 temporarily holds (stores) the input image data.

In Step S102, the ROI tracking and detection section 113 tracks and detects an ROI by referring to the image data input in Step S101, and detects ROI information and an ROI motion vector.

In Step S103, the segmented region setting section 114 executes segmented region setting processing, and sets a segmented region and generates segmented region information on the basis of the ROI information and the ROI motion vector detected in Step S102 (that is, on the basis of a motion of the ROI to date).

In Step S104, the segmentation section 115 reads the image data temporarily stored (held) in the input image buffer 112, and segments a segmented image from the input image on the basis of the segmented region information set in Step S103.

In Step S105, the image coding section 116 codes the segmented image segmented in Step S104, and generates segmented image coded data.

In Step S106, the coded data output section 117 outputs the segmented image coded data generated in Step S105 to the outside.

In Step S107, the control section 101 determines whether or not processing on all images is completed. In a case in which it is determined that an unprocessed image (for example, frame, slice, or tile) is present, the processing returns to Step S101 and subsequent processing is repeated.

In such a way, in a case in which the processing in Steps S101 to S107 is repeated and it is determined in Step S107 that processing on all images is completed, the image coding processing is over.

By performing the image coding processing in such a way, the segmented image at the position response to the motion of the ROI is segmented and coded, and thus, it is possible to reduce the probability that the ROI deviates from the segmented region and suppress the reduction in the image quality of the decoded image (segmented image or ROI image).

### <Flow of Segmented Region Setting Processing>

A segmented region setting method may be an optional method as long as the method is based on the motion of the ROI to date (that is, the ROI information and the ROI motion vector), as described above.

For example, the segmented region may be set in such a manner that a position to which the ROI is moved from a current central position of the ROI in the same direction by the same distance as a direction and a distance of the motion of the ROI is assumed as a central position of the segmented region. In other words, the segmentation section 115 may set the position to which the ROI moves from the current central position of the ROI in the same direction by the same distance as the direction and the distance of the motion of the ROI as the central position of the segmented region, and segment a segmented image thereof from the input image.

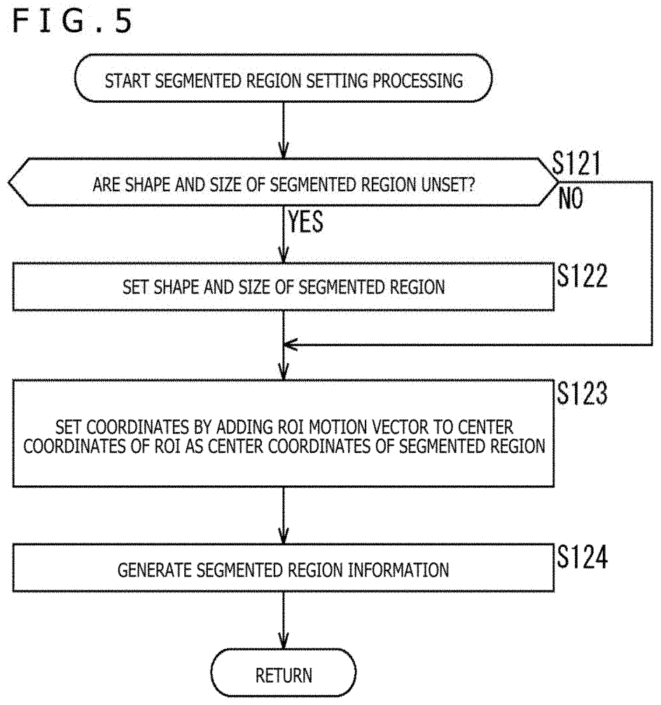

An example of a flow of segmented region setting processing executed in Step S103 of the image coding processing in FIG. 4 in that case will be described with reference to a flowchart of FIG. 5.

When the segmented region setting processing is started, the segmented region setting section 114 determines whether or not a shape and a size of the segmented region are unset in Step S121. When it is determined that the shape and the size of the segmented region are unset, the processing goes to Step S122.

In Step S122, the segmented region setting section 114 sets the shape and the size of the segmented region. As depicted in FIG. 3, the shape and the size of the segmented region may be designated by the control section 101, the user, or the like. The segmented region setting section 114 assumes the shape and the size of the segmented region as values (fixed values) set herein, and subsequently sets the segmented region at the shape and the size.

When the processing of Step S122 is over, the processing goes to Step S123. Further, in a case in which it is determined in Step S121 that the shape and the size of the segmented region are already set, the processing goes to Step S123.

In Step S123, the segmented region setting section 114 sets coordinates obtained by adding an ROI motion vector v to center coordinates C of the ROI as center coordinates C′ (C′=C+v) of the segmented region using the ROI information and the ROI motion vector.

In general, the motion of the ROI (an object image within the ROI) has continuity. That is, a probability is high that a future motion of the ROI is a motion closer to the motion of the ROI to date. In other words, there is the highest probability that the ROI moves from a current position by the same distance as the distance of the motion of the ROI to date (ROI motion vector v) in a next frame. That is, the probability is lower as the ROI is farther from the position.

In other words, it can be considered that setting the coordinates as the central position of the segmented region enables the lowest probability of deviation of the ROI from the segmented region (a state in which the ROI is not contained in the segmented region). Containing the ROI in the next frame in the segmented region makes it possible to use the segmented image in a current frame for the motion prediction of the ROI in the next frame. It is, therefore, possible to suppress the reduction in the image quality of the decoded image (segmented image or ROI image).

It is noted that the center coordinates of the ROI can be obtained on the basis of the ROI information.

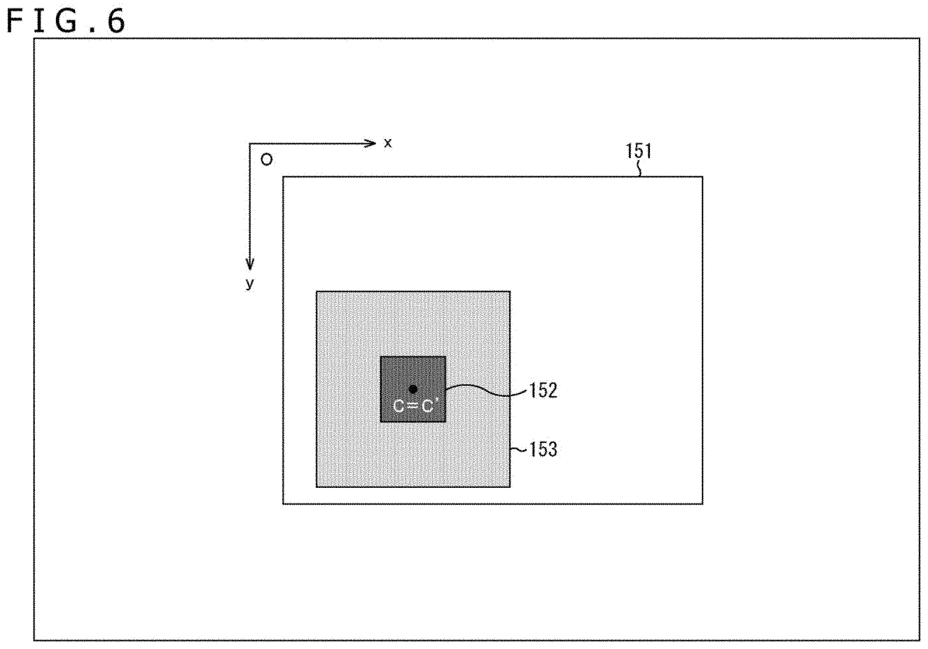

In a case, for example, in which the ROI does not move as in an example of FIG. 6, the ROI motion vector v is a zero vector. In other words, in a case of presence of an ROI 152 in an input image 151 as in the example of FIG. 6, the center coordinates C of the ROI 152 serve as the center coordinates C′ of a segmented region 153.

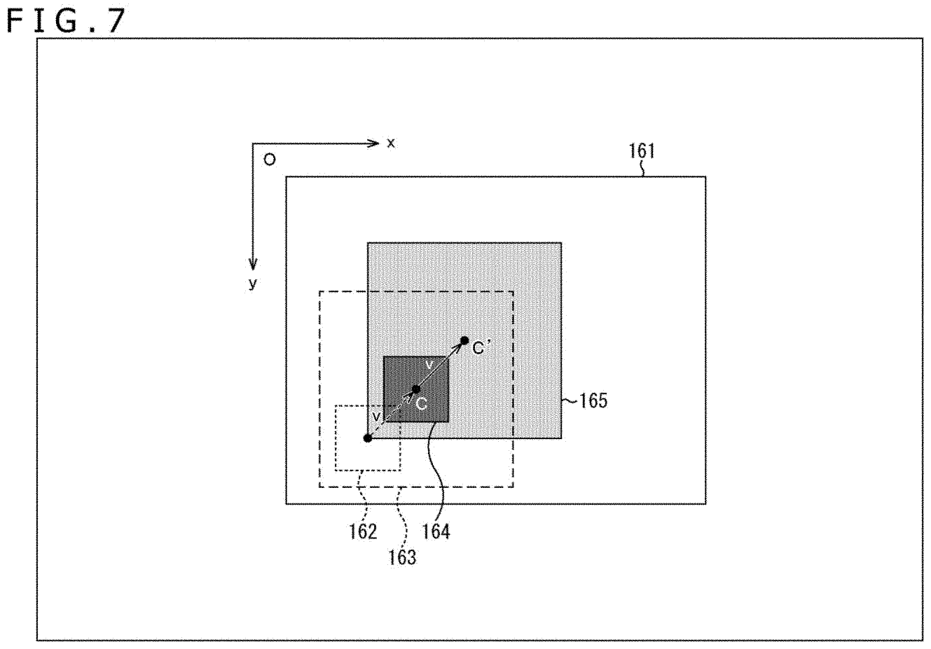

Further, it is assumed, for example, that an ROI 162 in a previous frame and an ROI 164 in the current frame are located in an input image 161 as in an example of FIG. 7. In addition, a segmented region 163 corresponding to the ROI 162 is set at a position as depicted in FIG. 7. In this case, a motion from the ROT 162 to the ROI 164 is the ROI motion vector v (dotted arrow). It is considered that there is the highest probability that the ROI similarly moves in the next frame, and thus, a segmented region 165 corresponding to the ROI 164 is set while setting, as the center coordinates C′, coordinates obtained by adding the ROI motion vector v (solid arrow) to the center coordinates C of the ROI 164, that is, coordinates moved from the center coordinates C of the ROI by as much as the ROI motion vector v (solid arrow) (C′=C+v).

Reference is made back to FIG. 5. Upon setting the position of the segmented region as described above, the segmented region setting section 114 generates segmented region information associated with the segmented region in Step S124. This segmented region information contains information indicating the shape, the size, and the position (coordinates) of the segmented region. The shape and the size of this segmented region are the values (fixed values) set in Step S122. In addition, the position (coordinates) of the segmented region is the position (coordinates) set in Step S123 (or information equivalent to the position (coordinates)). For example, the position of the segmented region may be represented by coordinates of an upper left end, an upper right end, a lower left end, a lower right end, or the like of the segmented region as an alternative to the center coordinates of the segmented region. Needless to say, the position of the segmented region may be represented by the position other than those described above.

Upon generation of the segmented region information, the segmented region setting processing is over and the processing returns to FIG. 4.

Executing the segmented region setting processing as described above makes it possible to reduce the probability of the deviation of the ROI from the segmented region (the state in which the ROI is not contained in the segmented region) and to suppress the reduction in the image quality of the decoded image (segmented image or ROI image).

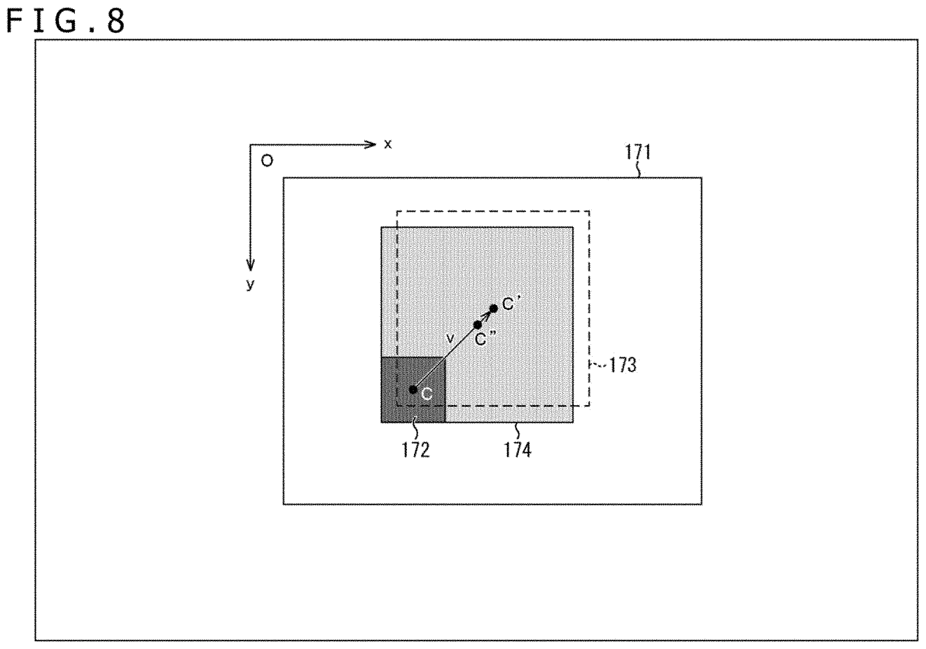

In the case of setting the ROI (Region Of Interest) (C′=C+v) as described above, a case in which the segmented region is incapable of containing the ROI (ROI in the current frame) corresponding to the segmented region due to the excessively large ROI motion vector v (due to an excessive movement amount of the ROI) is conceivable. Without containing the ROI in the current frame, it is inconveniently impossible to obtain the ROI in the current frame from the segmented image. In that case, as in an example of, for example, FIG. 8, the segmented region is moved to contain the ROI in the current frame and the center coordinates are adjusted.

In an input image 171 in the example of FIG. 8, if coordinates obtained by adding the ROI motion vector v to the center coordinates C of an ROI 172 are set as the center coordinates C′ of a segmented region 173, the segmented region 173 is located as denoted by a dotted line in FIG. 8 and does not contain the ROI 172.

Therefore, in such a case, the segmented region setting section 114 adjusts the central coordinates of the segmented region (to C″) so that the segmented region can be located to contain the ROI 172 like a segmented region 174. In other words, in the case in which the position moved from the central position C of the current ROI in the same direction the same distance as the direction and the distance of the motion of the ROI (position to which the ROI motion vector v is added) is set as the central position C′ of the segmented region and the segmented region does not contain the ROI, the segmented region setting section 114 sets, as the central position C′ of the segmented region, a position moved from the central position C of the current ROI in the same direction as the direction of the motion of the ROI to date by a maximum distance in a range in which the segmented region contains the ROI. The segmentation section 115 then segments a segmented image at such a position.

By doing so, it is possible to set the segmented region in such a manner as to always contain the current ROI (to ensure that the segmented region contains the current ROI).

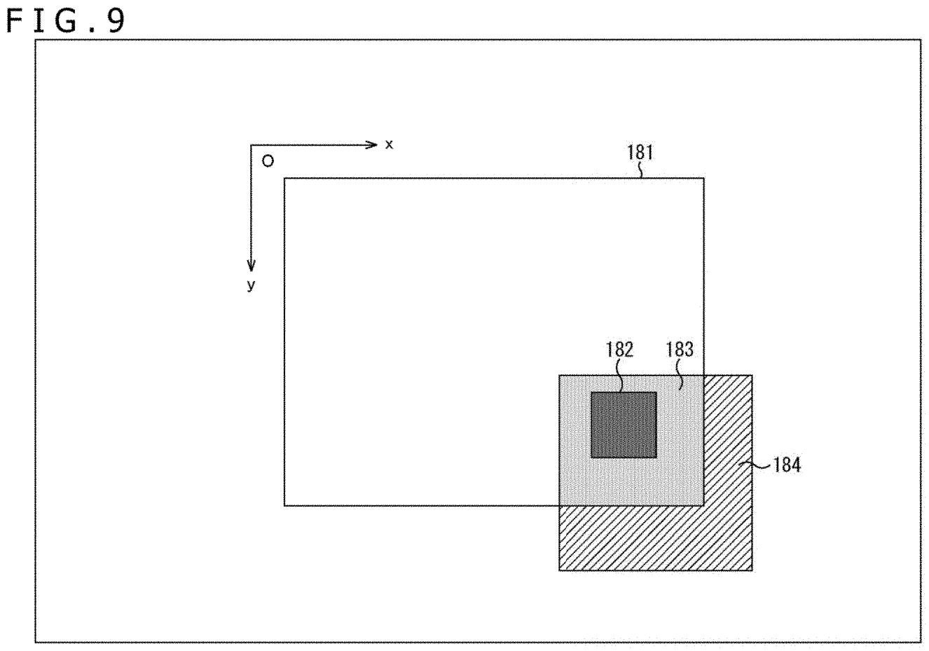

Further, when a segmented region extends off an input image frame as in an example of FIG. 9 in the case of setting the ROI (C′=C+v) as described above, then a region of the segmented region extending off the input image frame may be clipped and padding may be performed on a clipped part so that the shape and the size of the segmented region are fixed.

For example, in an input image 181 depicted in FIG. 9, it is assumed that a segmented region 183 corresponding to an ROI 182 is set as depicted in FIG. 9. In this case, the segmented region 183 is not contained in the input image 181. In other words, the segmented region 183 has a region 184 located outside of the input image 181. Since an image of the region 184 is not present, the segmented region setting section 114 performs padding on the region 184.

In other words, the segmented region setting section 114 adds a predetermined pixel value to the portion of the segmented region located outside of a frame of the input image. The segmentation section 115 then segments a segmented image on which such padding is performed.

By doing so, even in the case in which the segmented region extends off the input image, the shape and the size of the segmented image can be kept to the set values. It is noted that this padding may be arbitrarily performed (pixel value may be an optional value).

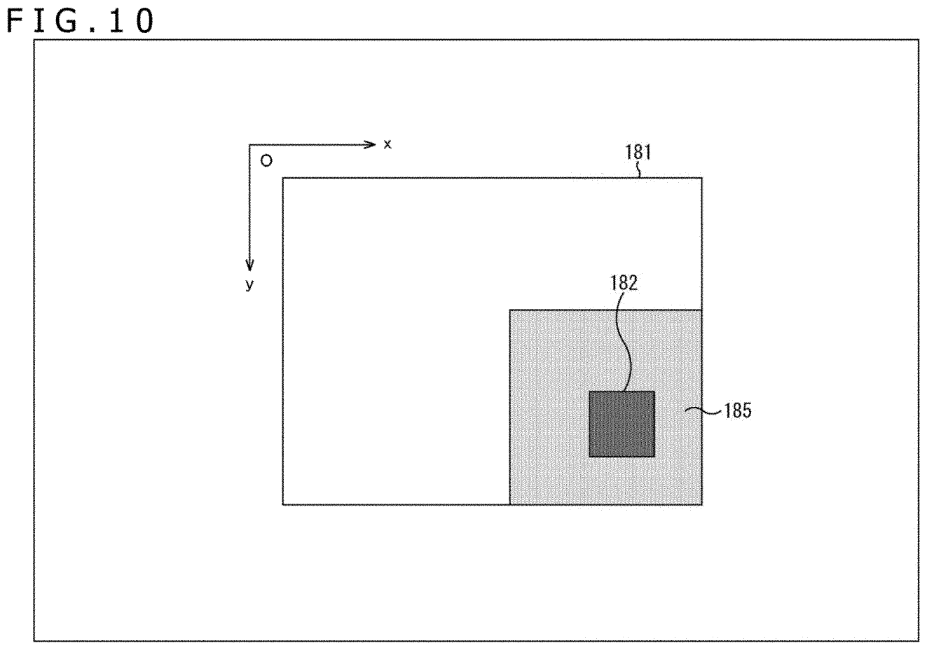

It is noted that in the case in which the segmented region extends off the input image as described above, control may be exercised in such a mariner that the segmented region does riot extend off the input image as depicted in, for example, FIG. 10 as an alternative to the padding. FIG. 10 depicts an example of correcting a position of the segmented region 183 in the example of FIG. 9 in such a manner that the segmented region 183 does riot to extend off the input image.

In FIG. 10, a segmented region 185 indicates an example of such a position-corrected segmented region. In the case of this example, the position of the segmented region 185 corresponding to the ROI 182 is set so that the segmented region 185 comes in contact with an outer frame of the input image 181 from within. In other words, center coordinates of the segmented region 185 are set to a position to which the center coordinates of the segmented region 185 are moved from center coordinates of the ROI 182 in a direction of the ROI motion vector v by the maximum distance in the range in which the segmented region does not extend off the input image 181.

In other words, when the input image does not contain the segmented region in the case of setting the position moved from the central position of the current ROI in the in the same direction by the same distance as the direction and the distance of the motion of the ROI as a central position of the segmented region, the segmented region setting section 114 sets, as the central position of the segmented region, the position moved from the central position of the current ROI in the same direction as the direction of the motion of the ROI to date by the maximum distance in the range in which the input image contains the segmented region. The segmentation section 115 then segments such a position-corrected segmented image.

By doing so, it is possible to set the segmented region without performing the padding, and thus, it is possible to suppress the reduction in the image quality of the segmented image. It is, therefore, also possible to suppress the reduction in the image quality of the ROI image.

While an example in which shapes of the ROI and the segmented region are all rectangular shapes has been described above, these shapes may be optional and are not limited to the example of the rectangular shapes. Moreover, the ROI motion vector may be obtained between optional frames as long as one of the frames temporally precedes the current frame. For example, the ROI motion vector may be obtained between the current frame and the past frame by two or more frames.

Further, while an example of setting the segmented region corresponding to one ROI has been described above, the present technology is not limited to this example and a common segmented region may be set to correspond to a plurality of ROIs. In other words, a plurality of ROIs may be present within one segmented region. In that case, the position of the segmented region may be set either on the basis of motions of the plurality of ROIs to date or on the basis of motions of part of the ROIs to date. For example, the center coordinates of the segmented region may be set on the basis of the ROI motion vector of one or a plurality of specific ROIs (for example, representative ROI such as the largest ROI or the most significant ROI). In the case of setting the center coordinates of the segmented region on the basis of the ROI motion vectors of the plurality of ROIs, the center coordinates of the segmented region may be set on the basis of, for example, a result of predetermined computing such as averaging the ROI motion vectors of the ROIs.

### 2. Second Embodiment

### <Image Coding Device>

While it has been described in the first embodiment that the motion of the ROI is obtained by tracking and detecting the ROI, a method of obtaining the motion of the ROI is not limited to this example and may be an optional method. For example, the motion of the ROI may be obtained using motion prediction of the segmented image.

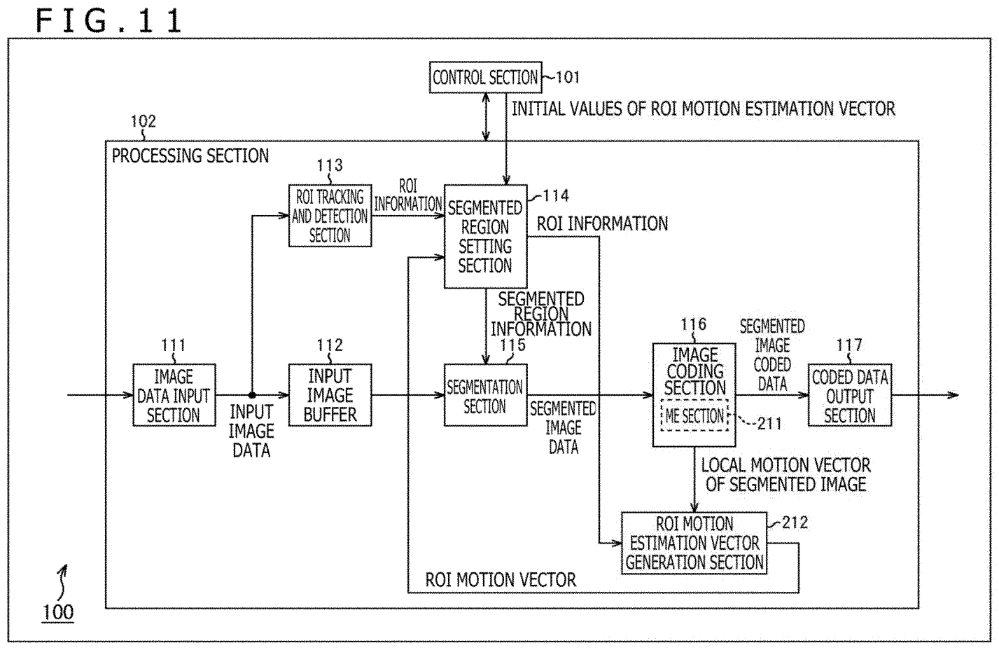

FIG. 11 is a block diagram depicting an example of principal configurations of the image coding device 100 in that case. While the image coding device 100 in a case of the example of FIG. 11 basically has similar configurations to those in the case of FIG. 1, the image coding section. 116 has an ME (Motion Estimation) section 211 in the case of FIG. 11. Further, the image coding device 100 has an ROI motion estimation vector generation section 212 in addition to the configurations depicted in FIG. 1.

Similarly to the case of FIG. 1, the image coding section 116 codes a segmented image (segmented image data) segmented by the segmentation section 115, and generates segmented image coded data. In this case, the image coding section 116 performs this coding using the motion prediction.

The ME section 211 performs the motion prediction, and generates a motion vector of each block in the segmented image (local motion vector of the segmented image). The ME section 211 supplies a result of the motion prediction, that is, the generated local motion vector of the segmented image to the ROI motion estimation vector generation section 212.

In this case, the ROI tracking and detection section 113 generates ROI information by tracking and detecting the ROI, and supplies the generated ROI information to the segmented region setting section 114. This ROI information is supplied to the ROI motion estimation vector generation section 212 via the segmented region setting section 114.

The ROI motion estimation vector generation section 212 acquires the ROI information supplied from the segmented region setting section 114 and the local motion vector of the segmented image supplied from the ME section 211. The ROI motion estimation vector generation section 212 generates an ROI motion estimation vector on the basis of those acquired information and the like. This ROI motion estimation vector is a vector indicating the motion of the ROI to date similarly to the ROI motion vector described above. However, the ROI motion estimation vector will be described while being distinguished from the ROI motion vector since the ROI motion estimation vector is generated on the basis of the local motion vector of the segmented image.

How an image of each part moves within the segmented image can be grasped by the local motion vector of the segmented image. Therefore, the ROI motion estimation vector generation section 212 obtains how an image at the position indicated by the ROI information moves within the segmented image from the local motion vector of the segmented image.

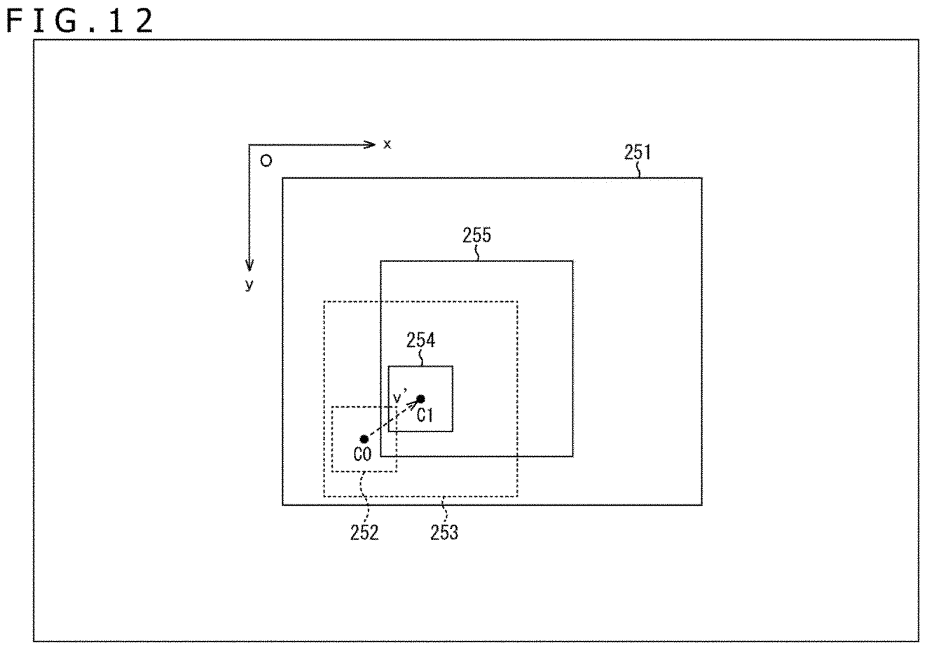

For example, as depicted in FIG. 12, it is assumed that an ROI 252 in a previous frame, a segmented region 253, an ROI 254 in a current frame, and a segmented region 255 are set in an input image 251. In other words, in this case, the ROI 252 moves up to the ROI 254 in a similar manner to a motion vector v′, and the segmented region 253 moves up to the segmented region 255.

The ME section 211 processes only a segmented image, and thus, when attention is paid only to an interior of the segmented region, an image within the segmented region moves in an opposite direction to a direction of movement of the segmented region in response to the movement of the segmented region described above. An image within the ROI 254, for example, is located near a center of the segmented region 253 but located near a lower left corner of the segmented region 255.

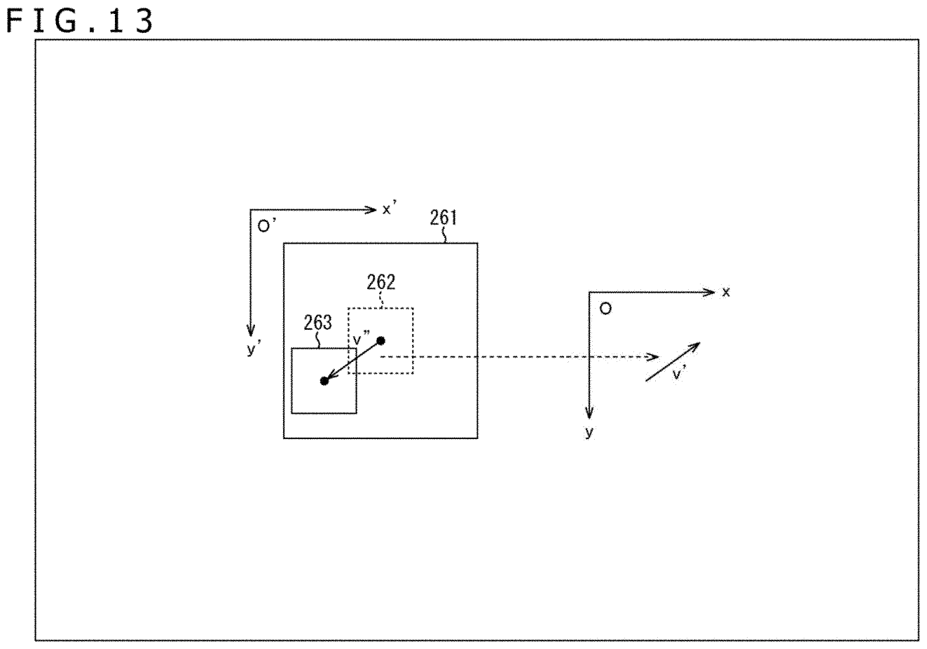

When attention is paid to this movement only for one segmented region (segmented image), the image moves from neighborhoods of a center of a segmented image 261 (an ROI 262) to neighborhoods of a lower left corner (an ROI 263), as depicted in FIG. 13. In other words, the ROI motion estimation vector generation section 212 estimates such a motion vector v″ from the local motion vector of the segmented image.

This motion vector v″ is a global motion vector indicating a motion of the overall ROI in the segmented image 261. Actually, there is a probability that a plurality of local motion vectors is also present within the ROI and indicate different motions. In general, an intended object contained in an ROI is often not a simple two-dimensional image such as a person or an object, and it is highly probable that motions other than the movement of the overall ROI described above are present. In such a case, a motion vector group within the ROI is diversified, and thus, there is a probability of an increase in errors when such a motion vector group within the ROI is used for deriving the global motion vector of the ROI.

To avoid such errors, the ROI motion estimation vector generation section 212 masks (excludes) an interior of the ROI using the ROI information, and derives (estimates) the global motion vector of the ROI on the basis of the local motion vectors outside of the ROI. By doing so, it is possible to suppress occurrence of the errors described above, and thus, it is possible to derive a more accurate global motion vector of the ROI and suppress the reduction in coding efficiency. In other words, it is possible to suppress the reduction in the image quality of the decoded image (segmented image or ROI image).

It is noted that this motion vector v″ (global motion vector of the ROI) is in the opposite direction to the direction of the motion vector v′, as described with reference to FIGS. 12 and 13. Th ROI motion estimation vector generation section 212, therefore, derives the motion vector v′, that is, ROI motion estimation vector v′ by inverting the direction of this motion vector v″.

The ROI motion estimation vector generation section 212 supplies the derived ROI motion estimation vector v′ to the segmented region setting section 114.

Similarly to the first embodiment, the segmented region setting section 114 sets a segmented region using the ROI information supplied from the ROI tracking and detection section 113 and the ROI motion estimation vector v′ supplied from the ROI motion estimation vector generation section 212, and generates segmented region information. In other words, in this case, the segmented region setting section 114 sets the segmented region using the ROI motion estimation vector v′ as an alternative to the ROI motion vector v according to the first embodiment.

In other words, the segmented region setting section 114 sets the segmented region with the position in response to the motion of the ROI to date obtained on the basis of the motion prediction of the image of the segmented region by the image coding section 116 (ME section 211) set as a central position of the segmented region.

Further, similarly to the first embodiment, the segmented region setting section 114 also sets the shape and the size of the segmented region. For example, the segmented region setting section 114 sets the shape and the size of this segmented region to a preset predetermined shape and a preset predetermined size. Furthermore, this setting may be made by, for example, the control section 101 (or user or the lite) to the segmented region setting section 114.

The segmented region setting section 114 supplies these pieces of set information (such as the shape, the size, and the position) associated with the segmented region to the segmentation section 115 as segmented region information.

It is noted that the segmented region setting section 114 initially sets an initial value (for example, zero vector) of the ROI motion estimation vector since the motion prediction is not performed initially. The setting of this initial value may be made by, for example, the control section 101 as depicted in FIG. 11. For example, the user or the like may input information associated with the initial value of the ROI motion estimation vector, and the control section 101 may set the initial value of the ROI motion estimation vector to the segmented region setting section 114 on the basis of the information. At that time, the user may confirm the input image and the ROI by the display means (such as a monitor) that is not depicted, and designate the initial value of the ROI motion estimation vector and the like by the input means (such as a keyboard or a mouse) that is not depicted.

Similarly to the first embodiment, the segmentation section 115 segments, from the input image supplied from the input image buffer 112, a segmented region (segmented image) designated by the segmented region information supplied from the segmented region setting section 114. In other words, the segmentation section 115 segments, from the input image, a partial region at a position in response to the motion of the region of interest to date within the input image.

Additionally, the segmentation section 115 segments the partial region with the position in response to the motion of the ROI to date obtained on the basis of the motion prediction of the image of the segmented region by the image coding section 116 (ME section 211) set as a central position of the partial region. Furthermore, the segmentation section 115 segments the segmented region at the preset shape and the preset size. The segmentation section 115 supplies image data regarding the segmented image (segmented image data) segmented in such a way to the image coding section 116.

Since the segmented image at the position in response to the motion of the ROI is segmented and coded as described above, the image coding device 100 can reduce a probability that the motion prediction is unsuccessful, and thus, it is possible to suppress the reduction in the image quality of the decoded image (segmented image or ROI image), similarly to the case of the first embodiment.

### <Flow of Image Coding Processing>

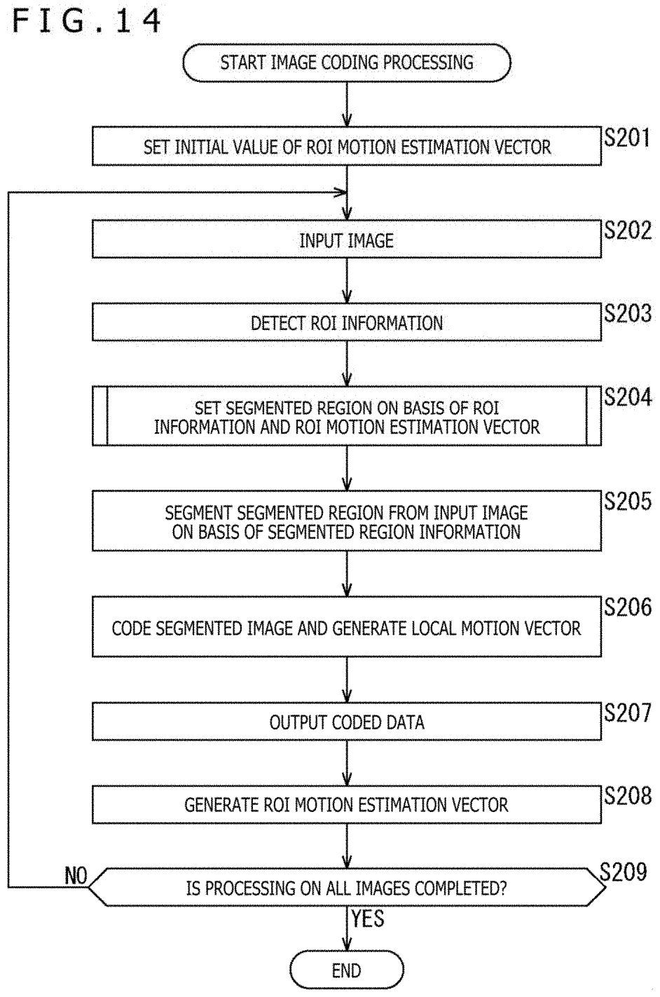

An example of a flow of image coding processing executed by the image coding device 100 in this case will next be described with reference to a flowchart of FIG. 14.

When the image coding processing is started, the control section 101 sets an initial value (for example, zero vector) of an ROI motion estimation vector to the segmented region setting section 114 in Step S201.

In Step S202, the image data input section 111 receives an image input from the outside in Step S202. The input image buffer 112 temporarily holds (stores) the input image data.

In Step S203, the ROI tracking and detection section 113 tracks and detects an ROI by referring to the image data input in Step S202, and detects ROI information.

In Step S204, the segmented region setting section 114 executes segmented region setting processing, and sets a segmented region and generates segmented region information on the basis of the ROI information detected in Step S203 and the ROI motion estimation vector (that is, on the basis of the motion of the ROI to date).

In Step S205, the segmentation section 115 reads the image data temporarily stored (held) in the input image buffer 112, and segments a segmented image from the input image on the basis of the segmented region information set in Step S204.

In Step S206, the image coding section 116 codes the segmented image segmented in Step S205, and generates segmented image coded data. In addition, the ME section 211 the image coding section 116 performs motion prediction during the coding, and generates a local motion vector of the segmented image.

In Step S207, the coded data output section 117 outputs the segmented image coded data generated in Step S206 to the outside.

In Step S208, the ROI motion estimation vector generation section 212 generates the ROI motion estimation vector on the basis of the ROI information detected in Step S203 and the local motion vector of the segmented image generated in Step S206. For example, the ROI motion estimation vector generation section 212 generates the global motion vector of the ROI with respect to the segmented image using the ROI information and the local motion vector of the segmented image, inverts the direction of the global motion vector, and generates the ROI motion estimation vector, as described above.

In Step S209, the control section 101 determines whether or not processing on all images is completed. In the case in which it is determined that an unprocessed image (for example, frame, slice, or tile) present, the processing returns to Step S202 and subsequent processing is repeated.

In such a way, in a case in which the processing in Steps S202 to S209 is repeated and it is determined in Step S209 that processing on all images is completed, the image coding processing is over.

By performing the image coding processing in such a way, the segmented image at the position in response to the motion of the ROI is segmented and coded, similarly to the case of the first embodiment, and thus, it is possible to reduce the probability that the ROI deviates from the segmented region and suppress the reduction in the image quality of the decoded image (segmented image or ROI image).

### <Flow of Segmented Region Setting Processing>

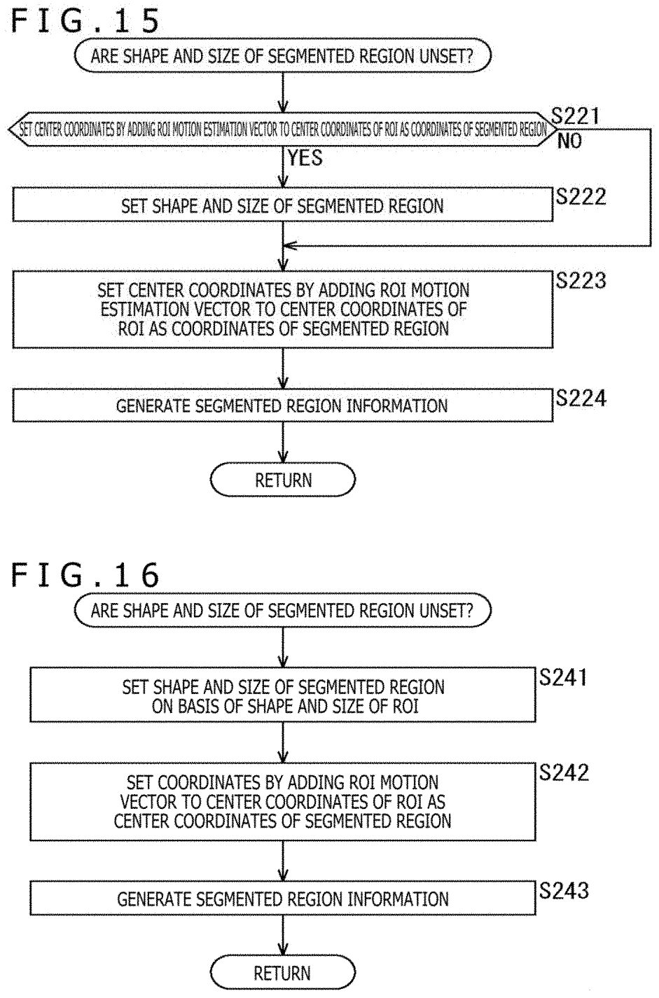

An example of a flow of segmented region setting processing executed in Step S204 of the image coding processing in FIG. 14 in this case will be described with reference to a flowchart of FIG. 15.

In this case, similar processing to that in the case of the first embodiment described with reference to a flowchart of FIG. 5 is performed. In other words, processing in Steps S221 to S224 is basically executed similarly to the processing in Steps S121 to S124 in the flowchart of FIG. 5. However, in Step S223, the segmented region setting section 114 sets the center coordinates of the segmented region using the ROI motion estimation vector v′ as an alternative to the ROI motion vector v. For example, the segmented region setting section 114 sets coordinates obtained by adding the ROI motion estimation vector v′ to the center coordinates C of the ROI as the center coordinates C′ (C′=C+v) of the segmented region.

Executing the segmented region setting processing as described above makes it possible to reduce the probability of the deviation of the ROI from the segmented region (the state in which the ROI is not contained in the segmented region) and to suppress the reduction in the image quality of the decoded image (segmented image or ROI image).

It is noted that the center coordinates of the segmented region corresponding to the current ROI may be adjusted in such a manner that the segmented region contains the ROI in the case of the present embodiment (case of using the ROI motion estimation vector), similarly to the case of the first embodiment. In other words, in the case in which the position moved from the central position C of the current ROI in the in the same direction by the same distance as the direction and the distance of the motion of the ROI (position to which the ROI motion estimation vector v is added) is set as the central position C′ of the segmented region and the segmented region does not contain the ROI, the segmented region setting section 114 sets, as the central position C′ of the segmented region, the position moved from the central position C of the current ROI in the same direction as the direction of the motion of the ROI to date by the maximum distance in the range in which the segmented region contains the ROI. The segmentation section 115 then segments a segmented image at such a position.

By doing so, it is possible to set the segmented region in such a manner as to always contain the current ROI (to ensure that the segmented region contains the current ROI).

Further, a region of the segmented region extending off the input image frame may be clipped and padding may be performed on the clipped part so that the shape and the size of the segmented region are fixed. In other words, the segmented region setting section 114 adds a predetermined pixel value to the portion of the segmented region located outside of a frame of the input image. The segmentation section 115 then segments a segmented image on which such padding is performed.

By doing so, even in the case in which the segmented region extends off the input image, the shape and the size of the segmented image can be kept to the set values. It is noted that this padding may be arbitrarily performed (pixel value may be an optional value).

Alternatively, control may be exercised in such a manner that the segmented region does not extend off the input image as an alternative to the padding. In other words, when the input image does not contain the segmented region in the case of setting the position moved from the central position of the current ROI in the in the same direction by the same distance as the direction and the distance of the motion of the ROI to date as the central position of the segmented region, the segmented region setting section 114 sets, as the central position of the segmented region, the position moved from the central position of the current ROI in the same direction as the direction of the motion of the ROI to date by the maximum distance in the range in which the input image contains the segmented region. The segmentation section 115 then segments such a position-corrected segmented image.

By doing so, it possible to set the segmented region without performing the padding, and thus, is possible to suppress the reduction in the image quality of the segmented image. It is, therefore, also possible to suppress the reduction in the image quality of the ROI image.

It is noted that the shapes of the ROI and the segmented region may be optional and are not limited to the example of the rectangular shapes. Moreover, the ROI motion vector may obtained between optional frames as long as one of the frames is a temporally older than the current frame.

Furthermore, a common segmented region may be set to correspond to a plurality of ROIs. In other words, the plurality of ROIs may be present within one segmented region. In that case, the position of the segmented region may be set either on the basis of motions of the plurality of ROIs to date or on the basis of motions of part of the ROIs date. For example, the center coordinates of the segmented region may be set on the basis of the ROI motion estimation vector of one or a plurality of specific ROIs (for example, representative ROI such as the largest ROI or the most sign cant ROI). In the case of setting the center coordinates of the segmented region on the basis of the ROI motion estimation vectors of the plurality of ROIs, the center coordinates of the segmented region may be set on the basis of, for example, a result of predetermined computing such as averaging the ROI motion estimation vectors of the ROIs.

### 3. Third Embodiment

### <Segmented Region Setting>

While it has been described in the embodiments above that the shape and the size of the segmented region are the fixed values, the present technology is not limited to the case and the shape and the size of the segmented region may be variable values. In other words, the segmented region setting section 114 may also set the shape and the size of the segmented region at the time of setting the segmented region.

A setting method of the shape and the size of the segmented region (what shape and what size are set) may be optional. For example, the segmented region setting section 114 may set the shape and the size of the segmented region on the basis of the shape and the size of the ROI by referring to the ROI information acquired from the ROI tracking and detection section 113 (determine the shape and the size of the segmented region in response to the shape and the size of the ROI). In other words, the segmentation section 115 may segment the segmented region at the shape and the size in response to the shape and the size of the ROI.

In any of the cases of the first and second embodiments described above, the shape and the size of the segmented region can be set to variable values.

### <Application in First Embodiment>

An example of a flow of segmented region setting processing executed in Step S103 of FIG. 4 in the case of setting the shape and the size of the segmented region to variable values in the case of, for example, the first embodiment will be described with reference to a flowchart of FIG. 16.

When the segmented region setting processing is started, the segmented region setting section 114 sets the shape and the size of the segmented region on the basis of the shape and the size of the ROI while referring to the ROI information in Step S241.

In Step S242, the segmented region setting section 114 sets coordinates obtained by adding the ROI motion vector v to the center coordinates C of the ROI as the center coordinates C′ (C′=C+v) of the segmented region using the ROI information and the ROI motion vector.

In Step S243, the segmented region setting section 114 generates the segmented region information associated with the segmented region. This segmented region information contains the information indicating the shape, the size, and the position (coordinates) of the segmented region. The shape and the size of this segmented region are values (variable values) set in Step S242. In addition, the position (coordinates) of the segmented region is the position (coordinates) set in Step S123 (or information equivalent to the position (coordinates)). For example, the position (coordinates) of the segmented region may be represented by the coordinates of the upper left end, the upper right end, the lower left end, the lower right end, or the like of the segmented region as an alternative to the center coordinates of the segmented region. Needless to say, the position (coordinates) of the segmented region may be represented by the position (coordinates) other than those described above.

Upon generation of the segmented region information, the segmented region setting processing is over and the processing returns to FIG. 4.

Executing the segmented region setting processing as described above makes it possible to set the segmented region at the appropriate shape and the appropriate size with respect to the shape and the size of the ROI. It is thereby possible to reduce the probability of the deviation of the ROI from the segmented region (the state in which the ROI is not contained in the segmented region) and to suppress an unnecessary expansion of the segmented region. It is, therefore, possible to suppress the reduction in the image quality of the decoded image (segmented image or ROI image), and suppress the reduction in coding efficiency.

### <Application in Second Embodiment>

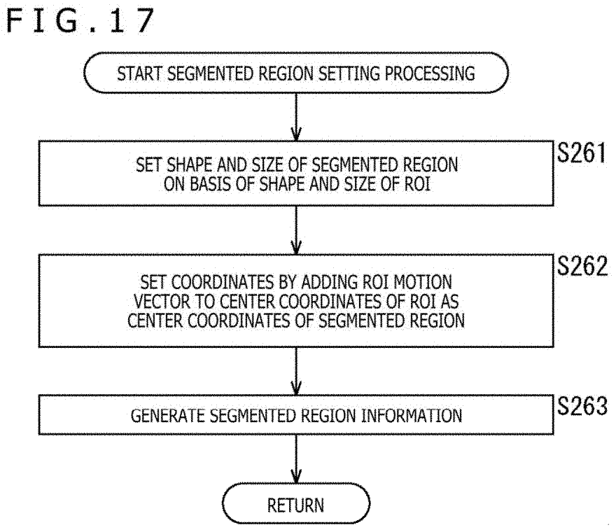

An example of a flow of segmented region setting processing executed in Step S204 of FIG. 14 in the case of setting the shape and the size of the segmented region to variable values in the case of the first embodiment will next be described with reference to a flowchart of FIG. 17.

In this case, similar processing to that described with reference to the flowchart of FIG. 16 is performed. In other words, processing in Steps S261 to S263 is basically executed similarly to the processing in Steps S241 to S243 in the flowchart of FIG. 16. However, in Step S242, the segmented region setting section 114 sets the center coordinates of the segmented region using the ROI motion estimation vector v′ as an alternative to the ROI motion vector v. For example, the segmented region setting section 114 sets the coordinates obtained by adding the ROI motion estimation vector v′ to the center coordinates C of the ROI as the center coordinates C′ (C′=C+v′) of the segmented region.

Executing the segmented region setting processing as described above makes it possible to set the segmented region at the appropriate shape and the appropriate size with respect to the shape and the size of the ROI. It is thereby possible to reduce the probability of the deviation of the ROI from the segmented region (the state in which the ROI is not contained in the segmented region) and to suppress an unnecessary expansion of the segmented region. It is, therefore, possible to suppress the reduction in the image quality of the decoded image (segmented image or ROI image), and suppress the reduction in coding efficiency.

### <Others>

It is noted that in the case of setting the shape and the size of the segmented region to variable values as described above, there is a probability that the shapes and sizes of the segmented images in frames are not made uniform (not identical to one another) to make it difficult for the image coding section 116 to perform coding. In such a case, padding processing or the like may be performed on the segmented images so that the shapes and the sizes of the segmented images in the frames are made uniform (made identical to one another).

Further, in the case of presence of a plurality of ROIs within one segmented region, the shape and the size of the segmented region may be set either on the basis of shapes and sizes of all the plurality of ROIs or on the basis of shapes and sizes of part of the ROIs. For example, the shape and the size of the segmented region may be set on the basis of the shape and the size of one or a plurality of specific ROIs (for example, representative ROI such as the largest ROI or the most significant ROI). In the case of setting the shape and the size of the segmented region on the basis of the shapes and the sizes of the plurality of ROIs, the shape and the size of the segmented region may be set on the basis of, for example, a result of predetermined computing such as an average value or a median value of the shapes and the sizes of the ROIs.

### 4. Fourth Embodiment

### <Signaling of ROI Separation Information>

A decoding side may be capable of extracting (separating) an ROI image from a reconstructed segmented image. In that case, information necessary to extract (separate) the ROI image (also referred to as “ROI separation information”) is only required to be provided from a coding side to the decoding side.

### <Image Coding Device>

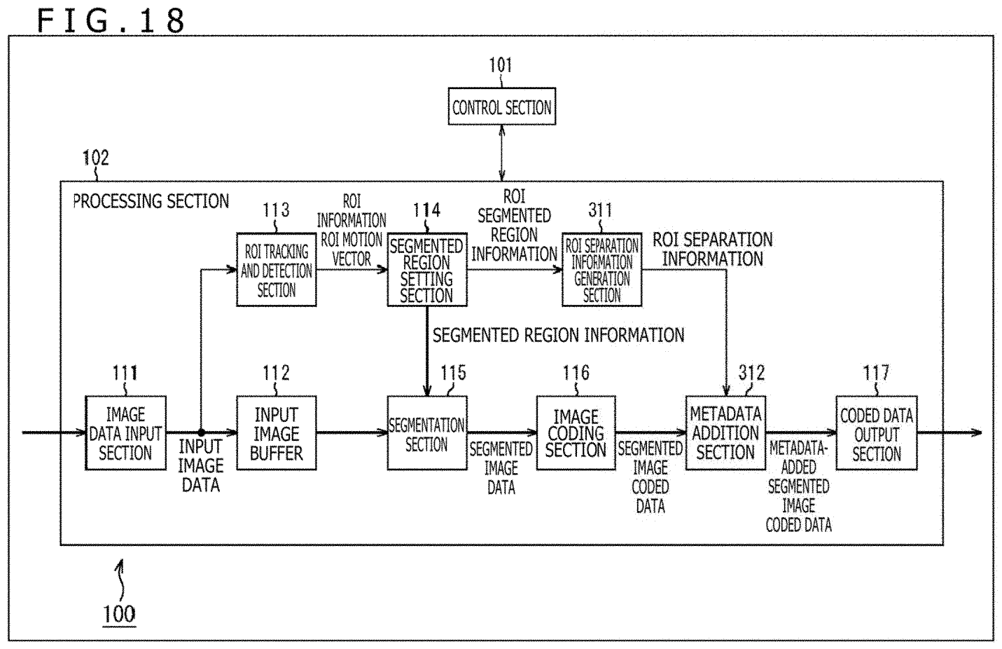

FIG. 18 is a block diagram depicting an example of principal configurations of the image coding device 100 at a time of providing the ROI separation information to the decoding side in the case of the first embodiment. In other words, the image coding device 100 of FIG. 18 sets the segmented region using the ROI motion vector detected by tracking and detecting the ROI, and yet provides the ROI separation information to the decoding side. While the image coding device 100 in a case of the example of FIG. 18 basically has similar configurations to those in the case of FIG. 1, the image coding device 100 further has an ROI separation information generation section 311 and a metadata addition section 312 as well as the configurations of FIG. 1.

The ROI separation information generation section 311 performs processing associated with generation of the ROI separation information. For example, the segmented region setting section 114 supplies the ROI information and the segmented region information to the ROI separation information generation section 311. The ROI separation information generation section 311 acquires the ROI information and the segmented region information. In addition, the ROI separation information generation section 311 generates the ROI separation information on the basis of those pieces of information. Further, the ROI separation information generation section 311 supplies the generated ROI separation information to the metadata addition section 312.

The metadata addition section 312 performs processing associated with addition of metadata. For example, the image coding section 116 supplies the segmented image coded data generated by coding the segmented image data to the metadata addition section 312. The metadata addition section 312 acquires the segmented image coded data. In addition, the metadata addition section 312 acquires the ROI separation information supplied from the ROI separation information generation section 311.

The metadata addition section 312 adds the acquired ROI separation information to the acquired segmented image coded data as metadata. In other words, the metadata addition section 312 contains the ROI separation information for separating the ROI from the segmented region the segmented image coded data. The metadata addition section 312 then supplies the segmented image coded data to which the metadata is added (metadata-added segmented image coded data) to the coded data output section 117.

The coded data output section 117 outputs the metadata-added segmented image coded data supplied from the metadata addition section 312 to the outside.

By doing so, it is possible to output the ROI separation information while adding the ROI separation information to the segmented image coded data. In other words, the ROI separation information can be provided from the coding side to the decoding side. It is, therefore, possible for the decoding side to extract (separate) the ROI image from the segmented image.

### <Flow of Image Coding Processing>

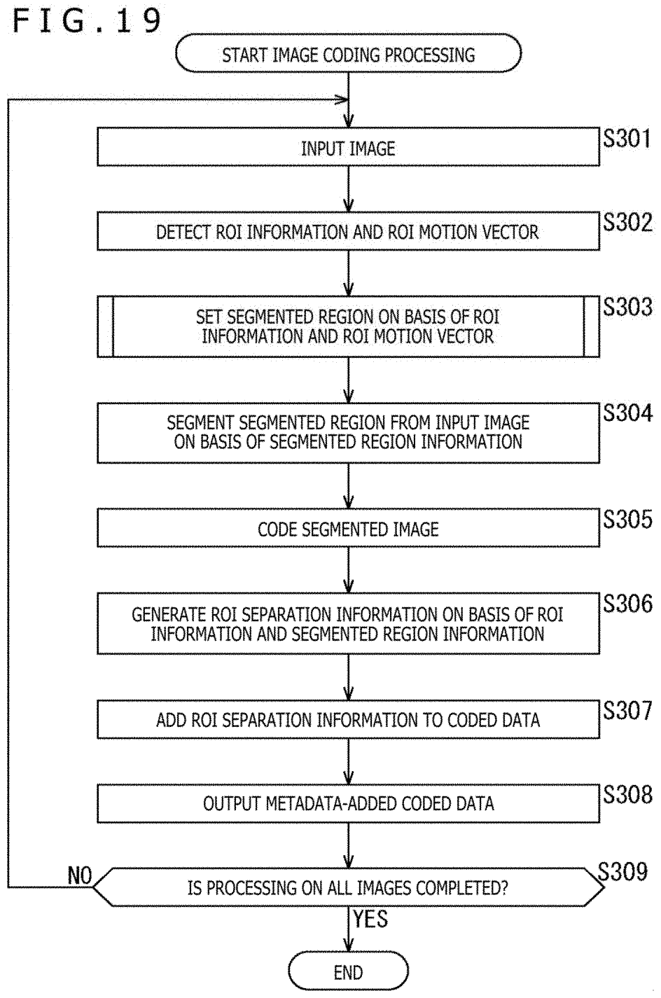

An example of a flow of image coding processing in this case will be described with reference to a flowchart of FIG. 19. When the image coding processing is started, processing in Steps S301 to S305 is executed similarly to the processing in Steps S101 to S105 of the flowchart of FIG. 4.

In Step S306, the ROI separation information generation section 311 generates ROI separation information on the basis of the ROI information and the segmented region information.

In Step S307, the metadata addition section 312 adds the ROI separation information generated in Step S306 to the segmented image coded data generated in Step S305, and generates metadata-added segmented image coded data.

In Step S308, the coded data output section 117 outputs the metadata-added segmented image coded data generated in Step S307 to the outside.

In Step S309, the control section 101 determines whether or not processing on all images is completed. In a case in which it is determined that an unprocessed image (for example, frame, slice, or tile) is present, the processing returns to Step S301 and subsequent processing is repeated.

In such a way, in a case in which the processing in Step S301 to S309 is repeated and it is determined in Step S309 that processing on all images is completed the image coding processing is over.

By performing the image coding processing in such a way, the ROI separation information can be provided from the coding side to the decoding side. It is, therefore, possible for the decoding side to extract (separate) the ROI image from the segmented image.

### <Application to Other Embodiments>

Although not depicted, the image coding device 100 in the case of the second embodiment may provide the ROI separation information from the coding side to the decoding side. In that case, similarly to the case of the first embodiment, the ROI separation information generation section 311 and the metadata addition section 312 may be provided in the image coding device 100 of FIG. 11, and those processing sections are only required to perform similar processing to the processing in the case of the first embodiment described above.

The similar thing is true for the image coding processing. In the image coding processing of FIG. 14, the processing in Steps S306 and S307 of FIG. 19 may be performed between the processing in Step S206 and the processing in Step S207, and the metadata-added segmented image coded data is only required to be output in the processing in Step S207.

Needless to say, the ROI separation information can be provided from the coding side to the decoding side in the third embodiment by a similar approach to that in the cases of the first and second embodiments.

### <Image Decoding Device>

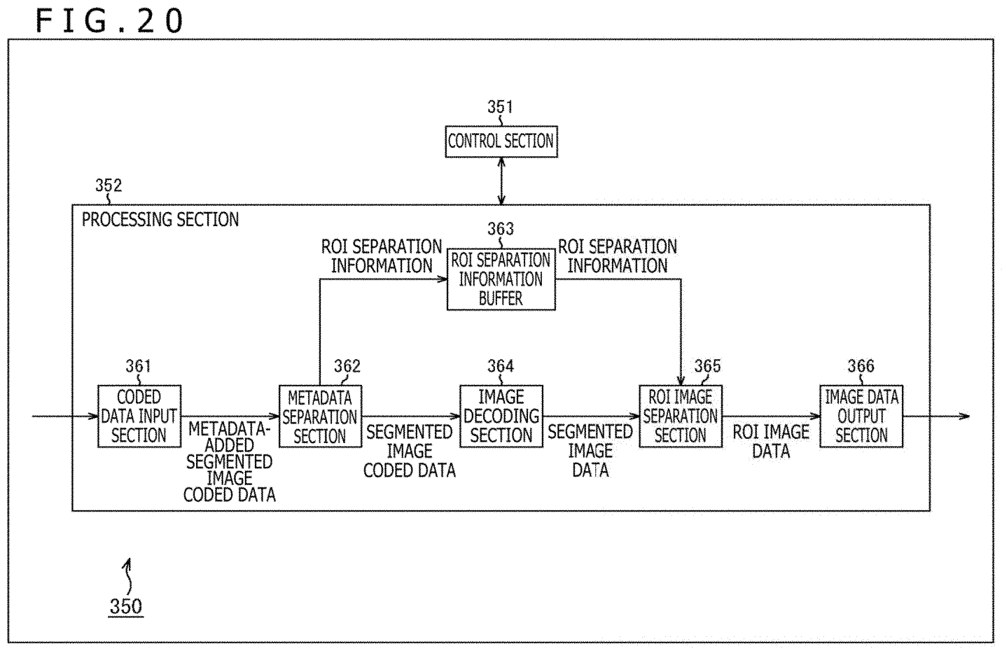

An image decoding device using the ROI separation information will next be described. FIG. 20 is a block diagram depicting an example of configurations of the image decoding device according to one aspect of the image processing device to which the present technology is applied. An image decoding device 350 depicted in FIG. 20 is a device that decodes the metadata-added segmented image coded data output from the image coding device 100 described above.

As depicted in FIG. 20, the image decoding device 350 has a control section 351 and a processing section 352. The control section 351 has, for example, a CPU, a ROM, a RAM, and the like, executes a predetermined program, and controls operations of the processing section 352. The processing section 352 performs processing associated with decoding of the metadata-added segmented image coded data under control of the control section 351.

As depicted in FIG. 20, the processing section 352 has a coded data input section 361, a metadata separation section 362, an ROI separation information buffer 363, an image decoding section 364, an ROI image separation section 365, and an image data output section 366.

The coded data input section 361 imports coded data (metadata-added segmented image coded data) supplied from the outside, and supplies the coded data (metadata-added segmented image coded data) to the metadata separation section 362.

The metadata separation section 362 performs processing associated with separation of the metadata (ROI separation information). For example, the metadata separation section 362 acquires the metadata-added segmented image coded data supplied from the coded data input section 361. In addition, the metadata separation section 362 extracts the metadata that contains the ROI separation information from the metadata-added segmented image coded data (separates the metadata-added segmented image coded data into the metadata (ROI separation information) and the segmented image coded data). In other words, the metadata separation section 362 extracts the ROI separation information for separating the ROI image from the segmented image from the segmented image coded data that contains the ROI separation information.

Further, the metadata separation section 362 supplies the ROI separation information to the ROI separation information buffer 363. In addition, the metadata separation section 362 supplies the segmented image coded data to the image decoding section 364.

The ROI separation information buffer 363 is a buffer intended to absorb a processing delay of the image decoding section 364. The ROI separation information buffer 363 temporarily holds (stores) the ROI separation information supplied from the metadata separation section 362. In addition, the ROI separation information buffer 363 supplies the stored ROI separation information to the ROI image separation section 365 at appropriate timing (or in response to a request).

The image decoding section 364 performs processing associated with image decoding. For example, the image decoding section 364 acquires the segmented image coded data supplied from the metadata separation section 362. In addition, the image decoding section 364 decodes the acquired segmented image coded data by a decoding method corresponding to a coding method of the image coding device 100 (image coding section 116), and generates (reconstructs) segmented image data. Further, the image decoding section 364 supplies the generated segmented image data to the ROI image separation section 365.

The ROI image separation section 365 performs processing associated with extraction (separation) of the ROI image from the segmented image. For example, the ROI image separation section 365 acquires the ROI separation information supplied from the ROI separation information buffer 363. In addition, the ROI image separation section 365 acquires the segmented image data supplied from the image decoding section 364. Furthermore, the ROI image separation section 365 segments (separates) an ROI image (ROI image data) from the segmented image (segmented image data) on the basis of the acquired ROI separation information. Moreover, the ROI image separation section 365 supplies the ROI image data (data regarding the ROI image) to the image data output section 366.

The image data output section 366 outputs the ROI image data supplied from the ROI image separation section 365 to the outside.

By doing so, the image decoding device 350 can accurately decode the metadata (ROI separation information)-added segmented image coded data. Further, the image decoding device 350 can extract (separate) the ROI image from the segmented image while referring to the ROI separation information.

### <Flow of Image Decoding Processing>

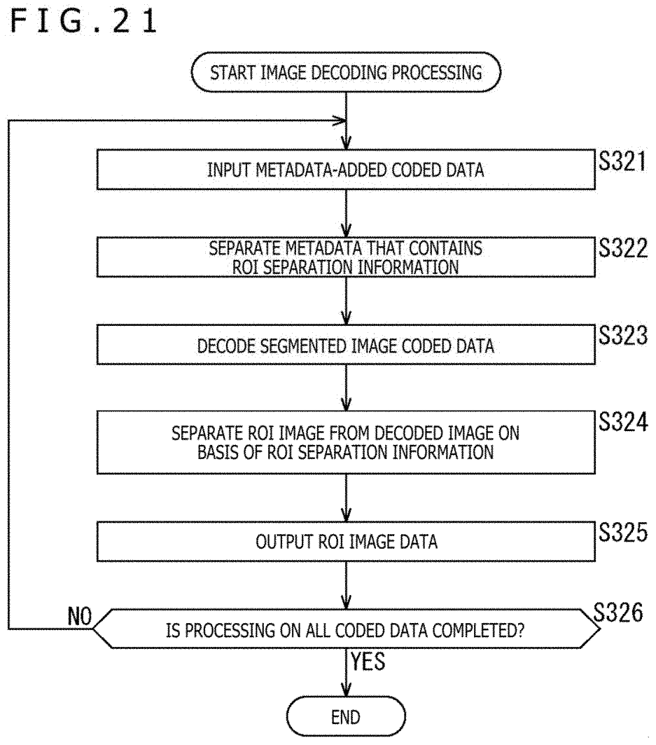

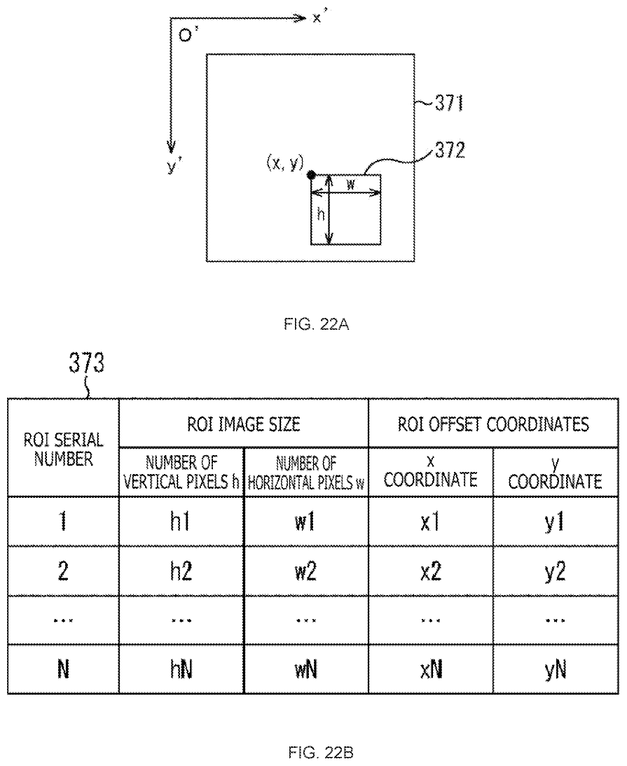

An example of a flow of image decoding processing in this case will be described with reference to a flowchart of FIG. 21. When the image decoding processing is started, the coded data input section 361 receives the metadata-added segmented image coded data input from the outside in Step S321.

In Step S322, the metadata separation section 362 separates metadata that contains ROI separation information from the metadata-added segmented image coded data input in Step S321. In other words, the metadata separation section 362 separates the metadata-added segmented image coded data into the metadata (ROI separation information) and the segmented image coded data. The ROI separation information buffer 363 temporarily holds (stores) the ROI separation information.

In Step S323, the image decoding section 364 decodes the segmented image coded data separated from the metadata in Step S322, generates (reconstructs) a segmented image, and generates data regarding the segmented image (segmented image data).

In Step S324, the ROI image separation section 365 extracts (separates) an ROI image from the segmented image generated (reconstructed) in Step S323 on the basis of the ROI separation information separated in Step S322, and generates data regarding the ROI image (ROI image data).

In Step S325, the image data output section 366 outputs the ROI image data generated in Step S324.

In Step S326, the control section 351 determines whether or not processing on all metadata-added segmented image coded data is completed. In a case in which it is determined that unprocessed metadata-added segmented image coded data (for example, frame, slice, or tile) is present, the processing returns to Step S321 and subsequent processing is repeated.

In such a way, in a case in which the processing in Step S321 to S326 is repeated and it is determined in Step S326 that processing on all metadata-added segmented image coded data is completed, the image decoding processing is over.

By performing the image decoding processing in such a way, it is possible to accurately decode the metadata (ROI separation information)-added segmented image coded data. Further, it is possible to extract (separate) the ROI image from the segmented image while referring to the ROI separation information.

### <ROI Separation Information>

It is noted that the ROI separation information may have optional specifications. The ROI separation information may contain any types of information. For example, the ROI separation information may contain ROI image frame information indicating the size of the ROI. In other words, the ROI separation information may contain information indicating the size of the ROI. Alternatively, the ROI separation information may contain, for example, ROI offset information indicating the position of the ROI. In other words, the ROI separation information may contain information indicating the position of the ROI in the segmented image. Needless to say, the ROI separation information may contain both the ROI image frame information and the ROI offset information. In other words, the ROI separation information may contain both the information indicating the size of the ROI and the information indicating the position of the ROI in the segmented image.

This ROI image frame information may contain, for example, parameters such as the number h of vertical pixels and the number of horizontal pixels w. As depicted in, for example, A of FIG. 22, the number of vertical pixels h is a parameter indicating a vertical size of the ROI (ROI 372 in A of FIG. 22) by the number of pixels. As depicted in, for example, A of FIG. 22, the number of horizontal pixels w is a parameter indicating a horizontal size of the ROI (ROI 372 in A of FIG. 22) by the number of pixels.

Moreover, the ROI offset information may contain, for example, parameters such as offset coordinates (x coordinate and y coordinate) of the ROI. As depicted in, for example, A of FIG. 22, the x coordinate is a parameter indicating an x coordinate of an upper left end of the ROI (ROI 372 in A of FIG. 22) in an image coordinate system of the segmented image (segmented image 371 in A of FIG. 22). As depicted in, for example, A of FIG. 22, the y coordinate is a parameter indicating a y coordinate of the upper left end of the ROI (ROI 372 in A of FIG. 22) in the image coordinate system of the segmented image (segmented image 371 in A of FIG. 22).

It is noted that in a case in which the shape of the ROI is unknown (variable), it is sufficient that the ROI separation information further contains information indicating the shape of the ROI. In other words, the ROI separation information may contain the information indicating the shape and the size of the ROI and the information indicating the position of the ROI in the segmented image. The example described above is an example in which the ROI has a rectangular shape (known shape).

Further, in the case in which a plurality of ROIs is present within one segmented image, then the ROI separation information may be generated per ROI and the ROI separation information regarding the plurality of ROIs may be added to the segmented image coded data as the metadata. Moreover, as in, for example, a table 373 depicted in B of FIG. 22, the ROI separation information regarding the plurality of ROIs may be summarized into one and added to the segmented image coded data.

The ROI separation information may be stored in an optional location. In a case of, for example, coding and decoding the segmented image by a method compliant with an image coding standard such as AVC or HEVC, this ROI separation information may be stored in a picture parameter set (PPS) as information per picture. Alternatively, this ROI separation information may be stored in, for example, a header of a slice or a tile as information per slice or tile. In another alternative, the ROI separation information regarding frames may be integrally stored in a sequence parameter set (SPS) or a video parameter set (VPS).

### 5.Fifth Embodiment

### <Parallel Coding of a Plurality of ROIs>

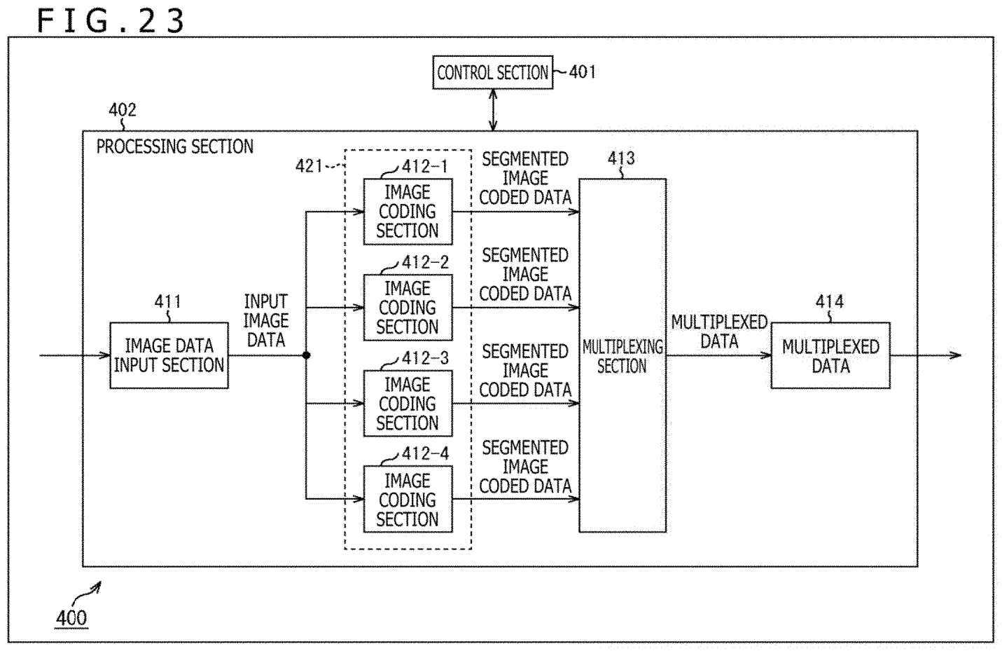

Image coding processing on a plurality of ROIs may be performed in parallel. FIG. 23 is a block diagram depicting an example of configurations of an image coding device according to one aspect of the image processing device to which the present technology is applied. An image coding device 400 depicted in FIG. 23 is a device that codes a plurality of ROIs in parallel to one another.

As depicted in FIG. 23, the image coding device 400 has a control section 401 and a processing section 402. The control section 401 has, for example, a CPU, a ROM, a RAM, and the like, executes a predetermined program, and controls operations of the processing section 402. The processing section 402 performs processing associated with coding of an image under control of the control section 401.

As depicted in FIG. 23, the processing section 402 has an image data input section 411, image coding sections 412-1 to 412-4, a multiplexing section 413, and a multiplexed data output section 414.

The image data input section 411 imports image data (input image data) supplied from the outside, and supplies the image data to the image coding sections 412-1 to 412-4.

Each of the image coding sections 412-1 to 412-4 codes an ROI within the supplied input image. The image coding sections 412-1 to 412-4 are similar processing sections and will be referred to as “image coding sections 412” in a case of no need to distinguish the image coding sections 412-1 to 412-4 in description. While the four image coding sections 412 are depicted in FIG. 23, the number of image coding sections 412 may be an optional number (that is, the image coding device 400 can have an optional number of image coding sections 412).

Each of the image coding sections 412 corresponds to the image coding device 100 described above in any of the first to fourth embodiments, has similar configurations to those of the image coding device 100, and performs similar processing to that by the image coding device 100. In other words, each of the image coding sections 412 sets a segmented region on the basis of the motion of the ROI contained in the input image to date, segments and codes the segmented region, and generates segmented image coded data.

Each of the image coding sections 412 supplies the generated segmented image coded data to the multiplexing section 413.

The multiplexing section 413 multiplexes the pieces of segmented image coded data supplied from the image coding sections 412-1 to 412-4, and generates multiplexed data. The multiplexing section 413 supplies the generated multiplexed data to the multiplexed data output section 414.

The multiplexed data output section 414 outputs the multiplexed data supplied from the multiplexing section 413 to the outside.

The image coding sections 412 perform herein processing for ROIs contained in the input image and different from one another. In other words, the image coding sections 412 set and segment segmented regions corresponding to the ROIs different from one another from the common input image, code segmented images, and generate pieces of segmented image coded data. In other words, the multiplexing section 413 multiplexes the pieces of segmented image coded data corresponding to the ROIs different from one another.

A method of allocating the ROI to be processed (setting what ROI as an object to be processed) to each of the image coding sections 412 may be an optional method. For example, the ROIs to be processed may be allocated to the image coding sections 412 in advance. Alternatively, the control section 401 may allocate (user or the like may allocate, via the control section 401,) the ROIs to the image coding sections 412.

The image coding sections 412 can perform processing on the allocated ROIs to be processed independently of one another. In other words, the image coding sections 412 can perform processing for setting the segmented regions on the basis of the motions of the ROIs to be processed contained in the input image to date, segmenting and coding the segmented regions, and generating the pieces of segmented image coded data in parallel to one another.

Therefore, the image coding device 400 can set and code the segmented images corresponding to more ROIs while suppressing an increase in processing time. In other words, the image coding device 400 can suppress the reduction in the image qualities of more decoded images (segmented images or ROI images) while suppressing the increase in the processing time.

It is noted that the image coding sections 412 are only required to be capable of performing processing independently of one another and are not necessarily configured physically independently. For example, the image coding sections 412 may be realized as cores, threads, or the like within one image coding section 421.

In that case, one image coding section 421 realizes similar configurations (processing sections and the like) to those of the image coding device 100 depicted in FIGS. 1, 11, or 18. It is to be noted, however, that the processing sections realized by the image coding section 421 can execute processing on the plurality of ROIs.

In other words, the segmentation section 115 realized by the image coding sections 412 may, for example, segment the segmented regions corresponding to the plurality of ROIs from the input image. In addition, the image coding section 116 realized by the image coding section 421 may code a plurality of segmented images segmented by the segmentation section 115.

Further, the segmentation section 115 may segment the segmented regions corresponding to the ROIs in parallel to one another. Moreover, the image coding section 116 may code the plurality of segmented images segmented by the segmentation section 115 in parallel to one another.

### <Flow of Image Coding Processing>

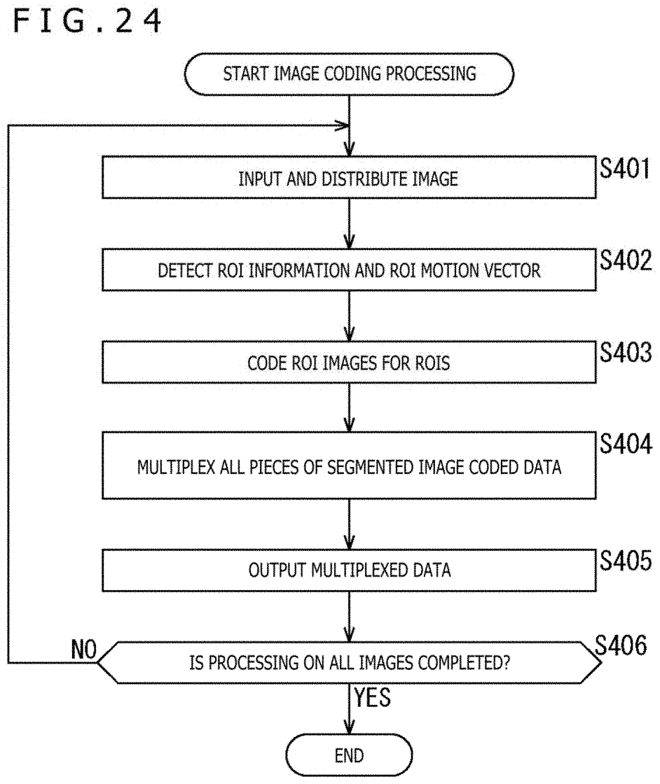

An example of a flow of image coding processing in this case will be described with reference to a flowchart of FIG. 24. When the image coding processing is started, the image data input section 411 receives input image data and acquires the image data as input image data in Step S401. In addition, the image data input section 411 distributes the input image data to all of the image coding sections 412.

The image coding sections 412 perform tracking and detection of the ROIs on the input image data and detect ROI information and ROI motion vectors in Step S402.

In Step S403, the image coding sections 412 code ROI images for the ROIs, respectively. In other words, the image coding sections 412 codes segmented images corresponding to the ROIs and generate pieces of segmented image coded data.

In Step S404, the multiplexing section 413 multiplexes the pieces of segmented image coded data corresponding to the ROIs, and generate multiplexed data.

In Step S405, the multiplexed data output section 414 outputs the multiplexed data to the outside.

In Step S406, the control section 401 determines whether or not the processing section 402 is completed with processing on all images (pictures, slices, tiles, or the like). In a case in which it is determined that an unprocessed image (picture, slice, or tile) is present, the processing returns to Step S401 and subsequent processing is repeated. In other words, the processing in Steps S401 to S406 is executed on each image. Further, in a case in which it is determined in Step S406 that processing on all images is completed, the image coding processing is over.

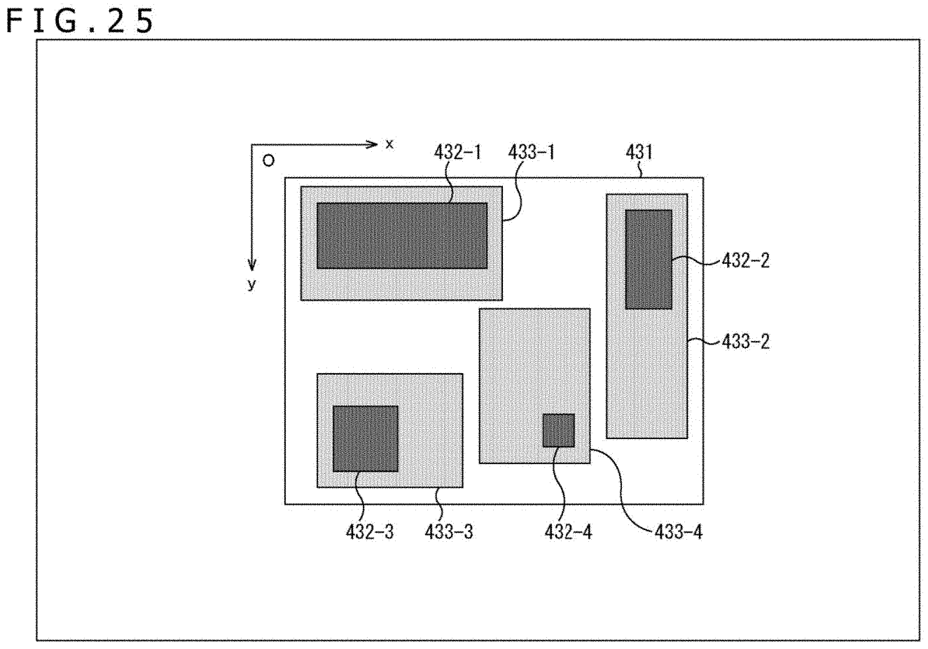

By executing the processing in such a way, it is possible to set the segmented regions to the plurality of ROIs and code images of the segmented regions (segmented images), as depicted in, for example, FIG. 25. In an example of FIG. 25, ROIs 432-1 to 432-4 are detected within an input image 431, and the image coding device 400 sets a segmented region 433-1 to the ROI 432-1, sets a segmented region 433-2 to the ROI 432-2, sets a segmented region 433-3 to the ROI 432-3, and sets a segmented region 433-4 to the ROI 432-4.

By doing so, it is possible to suppress the reduction in the image qualities of more decoded images (segmented images or ROI images) while suppressing the increase in processing time.

### 6. Sixth Embodiment

### <Serial Coding of a Plurality of ROIs>

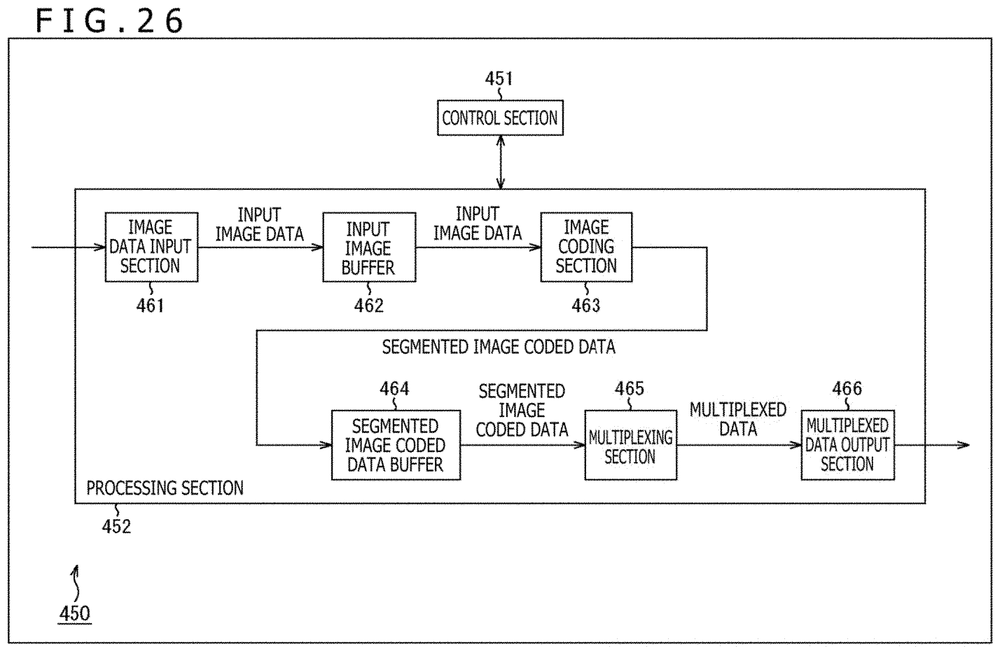

Image coding processing on a plurality of ROIs may be preformed sequentially (in series to one another). FIG. 26 is a block diagram depicting an example of configurations of an image coding device according to one aspect of the image processing device to which the present technology is applied. An image coding device 450 depicted in FIG. 26 is a device that codes a plurality of ROIs sequentially (in series).

As depicted in FIG. 26, the image coding device 450 has a control section 451 and a processing section 452. The control section 451 has, for example, a CPU, a ROM, a RAM, and the like, executes a predetermined program, and controls operations of the processing section 452. The processing section 452 performs processing associated with coding of an image under control of the control section 451.

As depicted in FIG. 26, the processing section 452 has an image data input section 461, an input image buffer 462, an image coding section 463, a segmented image coded data buffer 464, a multiplexing section 465, and a multiplexed data output section 466.

The image data input section 461 imports image data (input image data) supplied from the outside, and supplies the image data to the input image buffer 462.

The input image buffer 462 temporarily holds (stores) the input image data supplied from the image data input section 461, and supplies the input image data to the image coding section 463 at appropriate timing (given timing).

The image coding section 463 corresponds to the image coding device 100 described above in any of the first to fourth embodiments, has similar configurations to those of the image coding device 100, and performs similar processing to that by the image coding device 100. In other words, the image coding section 463 sets a segmented region on the basis of the motion of the ROI contained in the input image to date, segments and codes the segmented region, and generates segmented image coded data. The image coding section 463 then supplies the generated segmented image coded data to the segmented image coded data buffer 464.

The segmented image coded data buffer 464 temporarily holds (stores) the segmented image coded data supplied from the image coding section 463, and supplies the segmented image coded data to the multiplexing section 465 at appropriate timing (given timing).

The multiplexing section 465 multiplexes a plurality of pieces of segmented image coded data suppled from the segmented image coded data buffer 464, and generates multiplexed data. The multiplexing section 465 supplies the generated multiplexed data to the multiplexed data output section 466.

The multiplexed data output section 466 outputs the multiplexed data supplied from the multiplexing section 465 to the outside.

In the case herein in which a plurality of ROIs is set to the input image, the image coding section 463 can perform the processing described above on each ROI. In other words, the image coding section 463 can code the segmented image corresponding to each ROI, generate the segmented image coded data, and supply the segmented image coded data to the segmented image coded data buffer 464.

In other words, the segmentation section 115 owned by the image coding section 463, for example, may segment the segmented regions corresponding to the plurality of ROIs from the input image. Further, the image coding section 116 owned by the image coding section 463 may code a plurality of segmented images segmented by the segmentation section 115.

At that time, the image coding section 463 may process the ROIs sequentially (one by one). For example, the image coding section 463 selects one ROI to be processed from among unprocessed ROIs, and performs the processing described above on the ROI to be processed. Further, the image coding section 463 may process the ROIs one by one (process the ROIs sequentially) in such a way, and finally process all ROIs contained in the input image.

In other words, the segmentation section 115 owned by the image coding section 463 may sequentially segment the segmented images corresponding to the plurality of ROIs. Further, the image coding section 116 owned by the image coding section 463 may sequentially code the plurality of segmented images segmented by the segmentation section 115.

Therefore, the image coding device 450 can set and code the segmented images corresponding to more ROIs. In other words, the image coding device 450 can suppress the reduction in the image qualities of more decoded images (segmented images or ROI images).

### <Flow of Image Coding Processing>

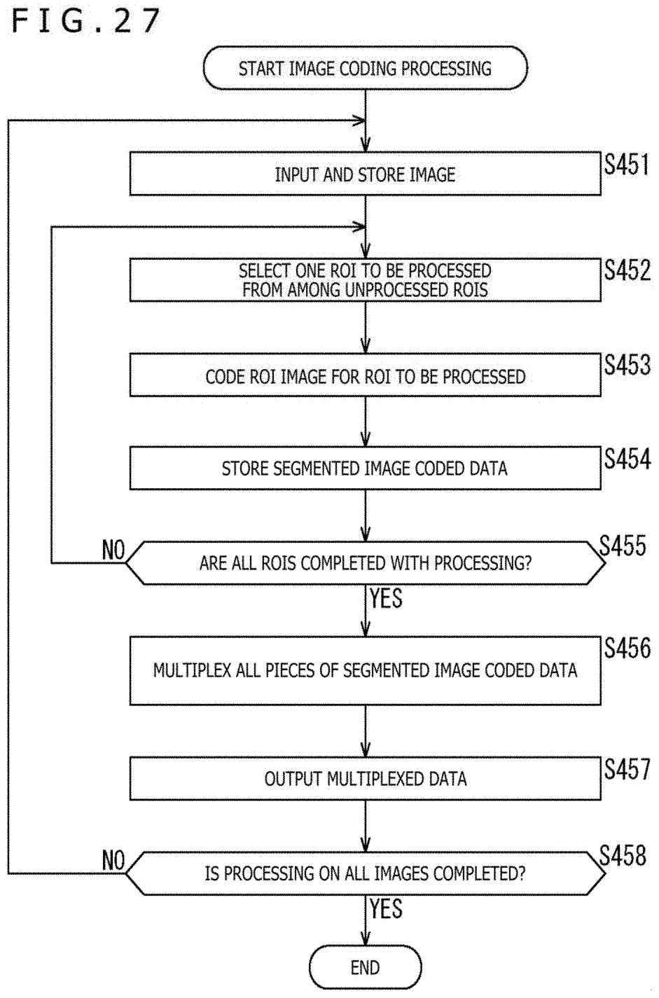

An example of a flow of image coding processing in this case will be described with reference to a flowchart of FIG. 27. When the image coding processing is started, the image data input section 461 receives input image data and acquires the image data as input image data in Step S451. In addition, the input image buffer 462 stores the input image data.

In Step 3452, the image coding section 463 selects one ROI to be processed from among unprocessed ROIs.

In Step S453, the image coding section 463 codes an ROI image for the ROI to be processed selected in Step S452. More specifically, the image coding section 463 sets a segmented region corresponding to the ROI to be processed, segments a segmented image that is an image of the segmented region from the input image, codes segmented image data that is data regarding the segmented image, and generates segmented image coded data.

In Step S454, the segmented image coded data buffer 464 stores the segmented image coded data generated in Step S453.

In Step S455, the image coding section 463 determines whether or not processing on all ROIs is completed. In a case in which it is determined that an unprocessed ROI is present, the processing returns to Step S452 and subsequent processing as repeated. In other words, the processing in Steps S452 to S455 is executed for each ROI. Further, in a case in which it is determined in Step S455 that processing on all ROIs is completed, the processing goes to Step S456.

In Step S456, the multiplexing section 465 multiplexes all segmented image coded data stored in the segmented image coded data buffer 464.

In Step S457, the multiplexed data output section 466 outputs the multiplexed data generated in Step S456.

In Step S458, the control section 451 determines whether or not the processing section 452 is completed with processing on all images (pictures, slices, tiles, or the like). In a case in which it is determined that an unprocessed image (picture, slice, or tile) is present, the processing returns to Step S451 and subsequent processing is repeated. In other words, the processing in Steps S451 to S458 is executed on each image. Further, in a case in which it is determined in yep S458 that processing on all images is completed, the image coding processing is over.

By executing the processing in such a way, it is possible to suppress the reduction in the image qualities of more decoded images (segmented images or ROI images).

### 7. Seventh Embodiment

### <Parallel Decoding of a Plurality of ROIs>

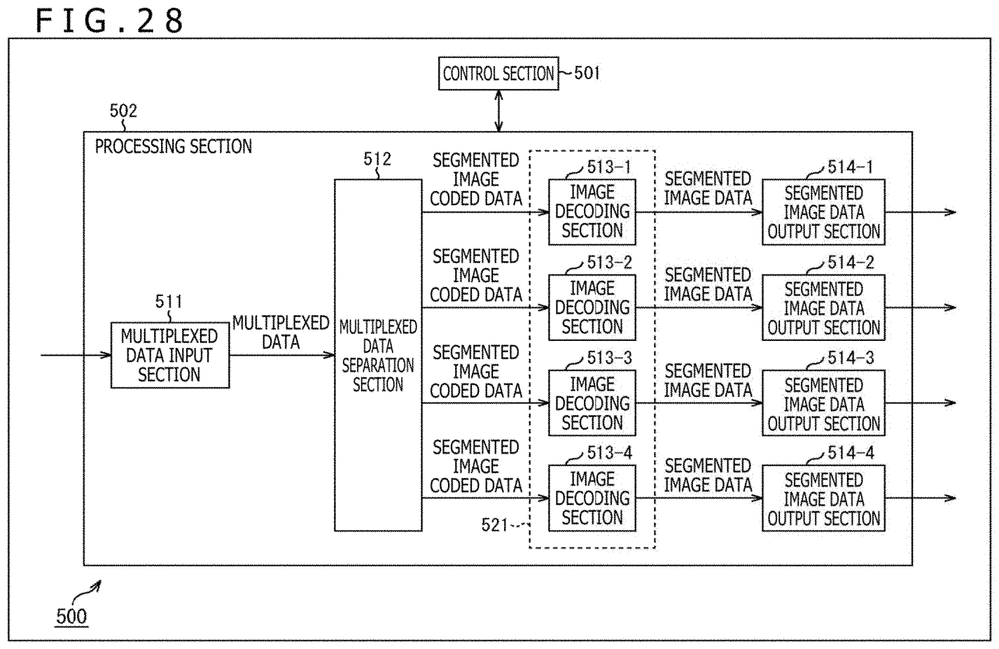

Image decoding processing on a plurality of ROIs may be performed in parallel to one another. FIG. 28 is a block diagram depicting an example of configurations of the image decoding device according to one aspect of the image processing device to which the present technology is applied. An image decoding device 500 depicted in FIG. 28 a device that decodes segmented image coded data corresponding to a plurality of ROIs in parallel to one another.

As depicted in FIG. 28, the image decoding device 500 has a control section 501 and a processing section 502. The control section 501 has, for example, a CPU, a ROM, a RAM, and the like, executes a predetermined program, and controls operations of the processing section 502. The processing section 502 performs processing associated with decoding of an image under control of the control section 501.

As depicted in FIG. 28, the processing section 502 has a multiplexed data input section 511, a multiplexed separation section 512, image decoding sections 513-1 to 513-4, and segmented image data output sections 514-1 to 514-4.

The multiplexed data input section 511 imports multiplexed data supplied from the outside and supplies the multiplexed data to the multiplexed separation section 512. This multiplexed data is data obtained by multiplexing a plurality of pieces of segmented image coded data, and is data generated by, for example, the image coding device 400 or 450.

The multiplexed separation section 512 separates the multiplexed data supplied from the multiplexed data input section 511 into pieces of segmented image coded data. The multiplexed separation section 512 supplies the pieces of segmented image coded data obtained by separation to the image decoding sections 513-1 to 513-4, respectively.

The image decoding sections 513-1 to 513-4 decode the supplied es of segmented image coded data and generate pieces of segmented image data. The image decoding sections 513-1 to 513-4 are processing sections similar to one another, and will be referred to as “image decoding sections 513” in case of no need to distinguish the image decoding sections 513-1 to 513-4 in description. While the four image decoding sections 513 are depicted in FIG. 28, the number of image decoding sections 513 may be an optional number (that is, the image decoding device 500 can have an optional number of image decoding sections 513).

The image decoding sections 513 decode the pieces of segmented image coded data supplied to themselves and generate the pieces of segmented image data. For example, each of the image decoding sections 513 may have similar configurations to those of the image decoding device 350 described above in the fourth embodiment and perform similar processing to that by the image decoding device 350.

The pieces of segmented image coded data separated by the multiplexed separation section 512 correspond to the ROIs different from one another. The multiplexed separation section 512 then supplies the pieces of segmented image coded data different from one another to the image decoding sections 513. In other words, the image decoding sections 513 decode the pieces of segmented image coded data corresponding to the ROIs different from one another.

The image decoding section 513-1 supplies the generated segmented image data to the segmented image data output section 514-1. Further, the image decoding section 513-2 supplies the generated segmented image data to the segmented image data output section 514-2. Moreover, the image decoding section 513-3 supplies the generated segmented image data to the segmented image data output section 514-3. Further, the image decoding section 513-4 supplies the generated segmented image data to the segmented image data output section 514-4.

The segmented image data output sections 514-1 to 514-4 are processing sections similar to one another, and will be referred to as “segmented image data output sections 514” in a case of no need to distinguish the segmented image data output sections 514-1 to 514-4 in description. While the four segmented image data output sections 514 are depicted in FIG. 28, the number of segmented image data output sections 514 may be an optional number (that is, the image decoding device 500 can have an optional number of segmented image data output sections 514).

The segmented image data output sections 514 output the pieces of segmented image data supplied from the image decoding sections 513 to the outside.

The image decoding sections 513 perform herein processing for ROIs contained in the input image and different from one another. In other words, the image decoding sections 513 decode the pieces of segmented image coded data corresponding to the ROIs different from one another within the common input image, and generate the pieces of segmented image data corresponding to the ROIs different from one another. The image decoding sections 513 can perform such processing independently of one another.

Therefore, the image decoding device 500 can decode the segmented image coded data corresponding to more ROIs and generate the segmented image data while suppressing the increase in processing time. In other words, the image decoding device 500 can suppress the reduction in the image qualities of more decoded images (segmented images or ROI images) while suppressing the increase in processing time.

It is noted that the image decoding sections 513 are only required to be capable of performing processing independently of one another and are not necessarily configured physically independently. For example, the image decoding sections 513 may be realized as cores, threads, or the like within one image decoding section 521.

In that case, one image decoding section 521 realizes similar configurations (processing sections and the like) to those of, for example, the image decoding device 350 depicted in FIG. 20. It is to be noted, however, that the processing sections realized by the image decoding section 521 can execute processing on the plurality of ROIs.

In other words, the image decoding section 364 realized by the image decoding section 521 may decode the pieces of segmented image coded data corresponding to the plurality of ROIs. The image decoding section 364 may then decode the pieces of segmented image coded data corresponding to the ROIs in parallel.

### <Flow of Image Decoding Processing>

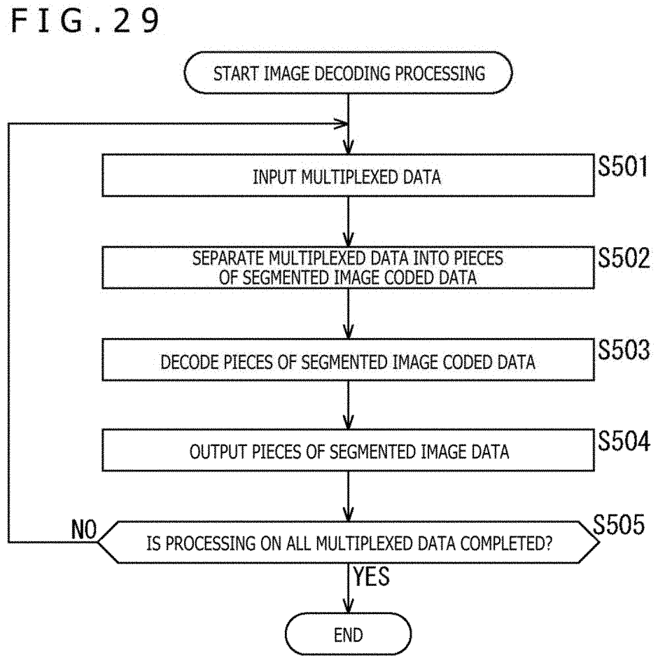

An example of a flow of image decoding processing in this case will be described with reference to a flowchart of FIG. 29. When the image decoding processing is started, the multiplexed data input section 511 receives and acquires input multiplexed data in Step S501.

In Step S502, the multiplexed separation section 512 separate the multiplexed data into pieces of segmented image coded data.

In Step S503, the image decoding sections 513 decode the pieces of segmented image coded data and generate pieces of segmented image data.

In Step S504, the segmented image data output sections 514 output the pieces of segmented image data.

In Step S505, the control section 501 determines whether or not processing on all multiplexed data is completed. In a case in which it is determined that unprocessed multiplexed data is present, the processing returns to Step S501. In a case in which the processing in Steps S501 to S505 is repeated in such a way and it is determined in Step S505 that processing on all multiplexed data is completed, the image decoding processing is over.

By executing the processing in such a way, it is possible to suppress the reduction in the image qualities of more decoded images (segmented images or ROI images) while suppressing the increase in processing time.

### 8. Eighth Embodiment

### <Serial Decoding of a Plurality of ROIs>

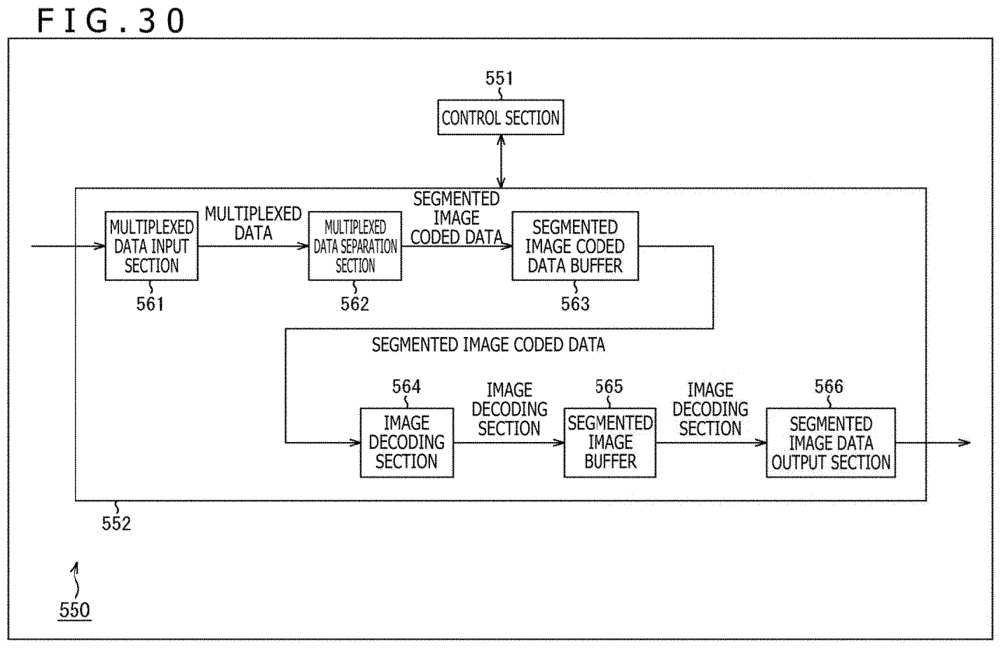

Image decoding processing on a plurality of ROIs may be performed sequentially (in series to one another). FIG. 30 is a block diagram depicting an example of configurations of the image decoding device according to one aspect of the image processing device to which the present technology is applied. An image coding device 550 depicted in FIG. 30 is a device that decodes segmented image coded data corresponding to a plurality of ROIs in parallel.

As depicted in FG. 30, the image coding device 550 has a control section 551 and a processing section 552. The control section 551 has, for example, a CPU, a ROM, a RAM, and the like, executes a predetermined program, and controls operations of the processing section 552. The processing section 552 performs processing associated with decoding of an image under control of the control section 551.

As depicted in FIG. 30, the processing section 552 has a multiplexed data input section 561, a multiplexed separation section 562, a segmented image coded data buffer 563, an image decoding section 564, a segmented image buffer 565, and a segmented image data output section 566.

The multiplexed data input section 561 imports multiplexed data supplied from the outside and supplies the multiplexed data to the multiplexed separation section 562. This multiplexed data is data obtained by multiplexing a plurality of pieces of segmented image coded data, and is data generated by, for example, the image coding device 400 or 450.

The multiplexed separation section 562 separates the multiplexed data supplied from the multiplexed data input section 561 into pieces of segmented image coded data. The multiplexed separation section 562 supplies the pieces of segmented image coded data obtained by separation to the segmented image coded data buffer 563.

The segmented image coded data buffer 563 temporarily holds (stores) the segmented image coded data supplied from the multiplexed separation section 562, and supplies the segmented image coded data to the image decoding section 564 at appropriate timing (given timing).

The image decoding section 564 decodes the pieces of supplied segmented image coded data and generates pieces of segmented image data. For example, the image decoding section 564 may have similar configurations to those of the image decoding device 350 described above in the fourth embodiment and perform similar processing to that by the image decoding device 350. The image decoding section 564 then supplies the generated segmented image data to the segmented image buffer 565.

The segmented image buffer 565 temporarily holds (stores) the segmented image data supplied from the image decoding section 564, and supplies the segmented image data to the segmented image data output section 566 at appropriate timing (given timing).

The segmented image data output section 566 outputs the segmented image data supplied from the segmented image buffer 565 to the outside.

The segmented image coded data buffer 563 may supply herein the pieces of segmented image coded data stored therein to the image decoding section 564 one by one (sequentially). The image decoding section 564 may then decode the pieces of supplied segmented image coded data one by one (sequentially).

Therefore, the image coding device 550 can decode the segmented image coded data corresponding to more ROIs. In other words, the image coding device 550 can suppress the reduction in the image qualities of more decoded images (segmented images or ROI images).

### <Flow of Image Decoding Processing>

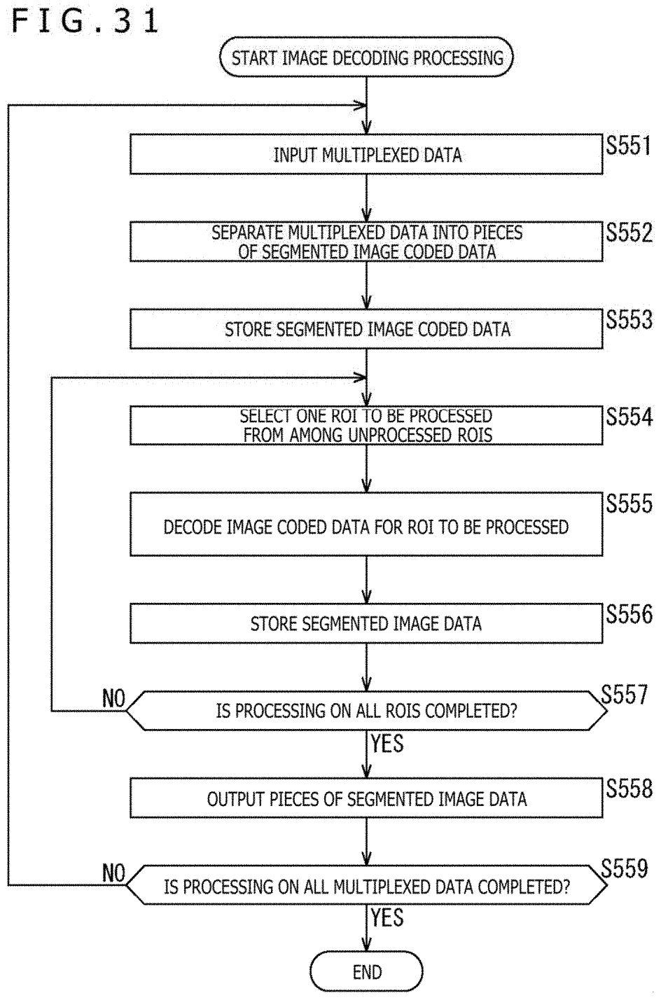

An example of a flow of image decoding processing in this case will be described with reference to a flowchart of FIG. 31. When the image decoding processing is started, the multiplexed data input section 561 receives and acquires input multiplexed data in Step S551.

In Step S552, the multiplexed separation section 562 separates the multiplexed data into pieces of segmented image coded data.

In Step S553, the segmented image coded data buffer 563 stores the pieces of segmented image coded data.

In Step S554, the image decoding section 564 selects one ROI to be processed from among unprocessed ROIs.

In Step S555, the image decoding section 564 reads the segmented image coded data from the segmented image coded data buffer 563 for the selected ROI to be processed, decodes the segmented image coded data, and generates segmented image data.

In Step S556, the segmented image buffer 565 stores the segmented image data.

In Step S557, the image decoding section 564 determines whether or not processing on all ROIs is completed. In a case in which it is determined that an unprocessed ROI is present, the processing returns to Step S554. In such a way, in a case in which the processing in Steps S554 to S557 is performed on each ROI and it is determined in Step S557 that processing on all ROIs is completed, the processing goes to Step S558.

In Step S558, the segmented image data output section 566 outputs the pieces of segmented image data stored in the segmented image buffer 565.

In Step S559, the control section 551 determines whether or not the processing section 552 is completed with processing on all multiplexed data. In a case in which it is determined that unprocessed multiplexed data is present, the processing returns to Step S551. In a case in which Steps S551 to S559 are executed on each multiplexed data in such a way and it is determined in Step S559 that processing on all multiplexed data is completed, the image decoding processing is over.

By executing the processing in such a way, it is possible to suppress the reduction in the image qualities of more decoded images (segmented images or ROI images).

### 9. Notes

### <Computer>

A series of processing described above can be executed by either hardware or software. In a case of executing a series of processing by the software, a program configuring the software is installed into a computer. Types of the computer include herein a computer incorporated into dedicated hardware, and a computer, which is, for example, a general-purpose personal computer, capable of executing various functions by installing various programs into the computer.

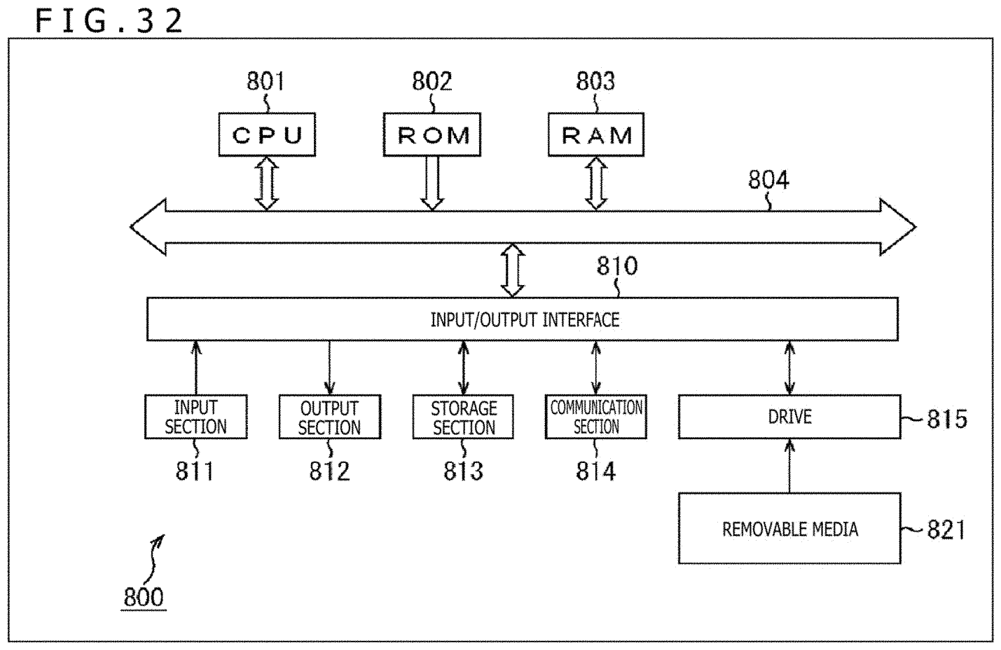

FIG. 32 is a block diagram depicting an example of configurations of the hardware of the computer executing the series of processing described above by a program.

In a computer 800 depicted in FIG. 32, a CPU (Central Processing Unit) 801, a ROM (Read Only Memory) 802, and a RAM (Random Access Memory) 803 are mutually connected via a bus 804.

An input/output interface 810 is also connected to the bus 804. An input section 811, an output section 812, a storage section 813, a communication section 814, and a drive 815 are connected to the input/output interface 810.

The input section 811 is configured from, for example, a keyboard, a mouse, a microphone, a touch panel, and an input terminal. The output section 812 is configured from, for example, a display, a speaker, and an output terminal. The storage section 813 is configured from, for example, a hard disk, a RAM disk, and a nonvolatile memory. The communication section 814 is configured from, for example, a network interface. The drive 815 drives a removable medium 821 such as a magnetic disk, an optical disk, a magneto-optical disk or a semiconductor memory.

In the computer configured as described above, the CPU 801 loads a program stored in, for example, the storage section 813 to the RAM 803 via the input/output interface 810 and the bus 804 and executes the program, thereby performing the series of processing described above. Data and the like necessary for the CPU 801 to execute various processing are also stored in the RAM 803 as appropriate.

The program executed by the computer (CPU 801) can be applied by, for example, being recorded in a removable medium 821 serving as a package medium or the like. In that case, the program can be installed into the storage section 813 via the input/output interface 810 by attaching the removable medium 821 to the drive 815.

Alternatively, this program can be provided via a wired or wireless transmission medium such as a local area network, the Internet, or a digital satellite service. In that case, the program can be received by the communication section 814 and installed into the storage section 813.

In another alternative, this program can be installed into the ROM 802 or the storage section 813 in advance.

### <Control Information>

Control information related to the present technology described in the embodiments so far may be transmitted from the encoding side to the decoding side. For example, control information (for example, enabled_flag) for controlling whether or not to permit (or prohibit) application of the present technology described above may be transmitted. Alternatively, control information indicating, for example, an object to which the present technology described above is applied (or object to which the present technology is not applied) may be transmitted. For example, control information for designating a block size (one of or both an upper limit and a lower limit of the block size), a frame, a component, a layer, or the like to which the present technology is applied (or for permitting or prohibiting the application) may be transmitted.

<Objects to which Present Technology is Applied>

The image processing device, the image coding device, and the image decoding device according to the embodiments described above are applicable to various electronic instruments such as a transmitter and a receiver (for example, a television receiver and a cellular telephone) in distribution on satellite broadcasting, wired broadcasting for a cable TV and the like, the Internet and in distribution to a terminal by cellular communication, and devices (for example, a hard disk recorder and a camera) for recording images in a medium such as an optical disk, a magnetic disk, and a flash memory and reproducing images from these storage mediums.

Further, the present technology can be carried out as any configurations mounted in an optional device or a device configuring a system, for example, as a processor (for example, video processor) serving as a system LSI (Large Scale Integration), a module (for example, video module) using a plurality of processors or the like, a unit (for example, video unit) using a plurality of modules or the like, a set (for example, video set) obtained by further adding other functions to the unit, or the like (that is, as partial configurations of the device).

Moreover, the present technology is also applicable to a network system configured with a plurality of devices. For example, the present technology is applicable to a cloud service for providing services associated with images (image sequence) to an optional terminal such as an AV (Audio Visual) instrument, a mobile information processing terminal, or an IoT (Internet of Things) device.

It is noted that systems, devices, processing sections, and the like to which the present technology is applied can be utilized in an optional field, for example, a field of transportation, medicine, crime prevention, agriculture, livestock, mining, beauty, factories, consumer electronics, weather, and nature monitoring. In addition, use applications of the present technology may be arbitrarily determined.

For example, the present technology is applicable to a system or a device used for providing listening and viewing contents. In addition, the present technology is applicable to, for example, a system or a device used for transportation such as monitoring of a traffic situation and autonomous driving control. Moreover, the present technology is applicable to, for example, a system or a device used for security. Furthermore, the present technology is applicable to, for example, a system or a device used for automatic control over machines and the like. Moreover, the present technology is applicable to, for example, a system or a device used for agriculture and livestock businesses. Further, the present technology is applicable to, for example, a system or a device for monitoring states of nature such as volcanos, forests, and oceans, wildlife, and the like. Moreover, the present technology is applicable to, for example, a system or a device used for sports.

### <Others>

It is noted that various information (such as metadata) related to coded data (bit stream) may be transmitted or recorded in any form as long as the various information is associated with the encoded data. A term “associate” means herein, for example, to allow the other data to be used (linked) at a time of processing one data. In other words, data associated with each other may be compiled as one data or individual pieces of data. For example, information associated with the coded data (image) may be transmitted on a transmission line different from a transmission line used to transmit the coded data (image). Further, the information associated with the coded data (image) may be recorded, for example, in a recording medium different from a recording medium in which the coded data (image) is recorded (or in a different recording area in the same recording medium). It is noted that this “association” may be association of not overall data but part of data. For example, an image and information corresponding to the image may be associated with each other in an optional unit such as a plurality of frames, one frame, or a portion in a frame.

It is noted that in the present specification, terms such as “combine,” “multiplex,” “add,” “integrate,” “contain/include,” “store,” “incorporate,” “plug,” and “insert” mean to compile a plurality of things into one, for example, to compile the coded data and the metadata into one data, and means one method for “associate” described above.

Moreover, the embodiments of the present technology are not limited to the embodiments described above and various changes can be made without departing from the spirit of the present technology.

Furthermore, the configuration described as one device (or one processing section), for example, may be divided and configured as a plurality of devices (or processing sections). Conversely, configurations described above as a plurality of devices (or processing sections) may be compiled and configured as one device (or one processing section). Moreover, needless to say, configurations other than those of each device (or each processing section) described above may be added to the configurations of each device (or each processing section). Furthermore, if the configurations or operations are substantially identical as an overall system, part of configurations of a certain device (or a certain processing section) may be included in the configurations of the other device (or other processing section).

It is noted that a system means in the present specification a collection of a plurality of constituent elements (devices, modules (components), and the like), regardless of whether or not all the constituent elements are provided in the same casing. Therefore, a plurality of devices accommodated in different casings and connected to one another via a network and one device in which a plurality of modules are accommodated in one casing can be both referred to as “system.”

For example, the present technology can have a cloud computing configuration for causing a plurality of devices to process one function in a sharing or cooperative fashion.

Further, the program described above can be executed by, for example, an optional device. In that case, the device may be configured with necessary functions (functional blocks or the like) to be capable of obtaining necessary information.

Furthermore, each step described in the above flowcharts can be not only executed by one device but also executed by a plurality of devices in a sharing fashion. Moreover, in a case in which one step includes a plurality of series of processing, the plurality of series of processing included in the one step can be not only executed by one device but also executed by a plurality of devices in a sharing fashion. In other words, the plurality of series of processing included in the one step can be executed as processing of a plurality of steps. Conversely, processing described as a plurality of steps may be compiled into one step and executed collectively.

It is noted that the program executed by a computer may be configured such that processes of steps describing the program are executed in time ser es in an order described in the present specification, or may be such that the processes are executed individually in parallel or at necessary timing such as timing of calling. In other words, the series of processing in the steps may be executed in an order different from the order described above unless contradiction arises. Further, the processing in the steps that describe this program may be executed in parallel to processing of the other program or may be executed in combination with the processing of the other program.

A plurality of present technologies described in the present specification can be carried out independently and solely only if there is inconsistency. Needless to say, a plurality of optional present technologies can be carried out in combination. For example, part of or entirety of the present technology described in any of the embodiments may be combined with part of or entirety of the present technology described in the other embodiment and the combination can be carried out. Further, part of or entirety of the optional present technology described above can be combined with the other technology that is not described above and the combination of the technologies can be carried out.

It is rioted that the present technology can be also configured as follows.

(1) An image processing device including:

a segmentation section that segments a partial region at a position in response to a motion of a region of interest within an image to date from the image; and

a coding section that codes an image of the partial region segmented from the image by the segmentation section, and that generates coded data.

(2) The image processing device according to (1), in which

the segmentation section sets, as a central position of the partial region, a position moved from a central position of the current region of interest in the same direction by the same distance as a direction and a distance of the motion of the region of interest to date.

(3) The image processing device according to (2), in which

the segmentation section adds a predetermined pixel value to a part of the partial region located outside of a frame of the image.

(4) The image processing device according to (1), in which

in a case of setting, as a central position of the partial region, a position moved from a central position of the current region of interest in the same direction by the same distance as a direction and a distance of the motion of the region of interest to date and the partial region does not contain the region of interest, the segmentation section sets, as the central position of the partial region, a position moved from the central position of the current region of interest in the same direction as the direction of the motion of the region of interest to date by a maximum distance in a range in which the partial region contains the region of interest.

(5) The image processing device according to (1), in which

in a case of setting, as a central position of the partial region, a position moved from a central position of the current region of interest in the same direction by the same distance as a direction and a distance of the motion of the region of interest to date and the partial region does not contain the region of interest, the segmentation section sets, as the central position of the partial region, a position moved from the central position of the current region of interest in the same direction as the direction of the motion of the region of interest to date by a maximum distance in a range in which the image contains the partial region.

(6) The image processing device according to (1), in which

the segmentation section segments the partial region with a position in response to the motion of the region of interest to date obtained by tracking and detecting the region of interest set as a central position of the partial region.

(7) The image processing device according to (1), in which

the segmentation section segments the partial region with a position in response to the motion of the region of interest to date obtained by motion prediction of an image of the partial region by the coding section as a central position of the partial region.

(8) The image processing device according to (1), in which

the segmentation section segments the partial region at a preset shape and a preset size.

(9) The image processing device according to (1), in which

the segmentation section segments the partial region at a shape and a size in response to a shape and a size of the region of interest.

(10) The image processing device according to (1), in which

the coding section contains region-of-interest separation information for separating the region of interest from the partial region in the coded data.

(11) The image processing device according to (10), in which

the region-of-interest separation information contains information indicating a shape and a size of the region of interest and information indicating a position of the region of interest in the partial region.

(12) The image processing device according to (1), in which

the segmentation section segments the partial regions corresponding to a plurality of the regions of interest, respectively, and

the coding section codes a plurality of the partial regions segmented by the segmentation section.

(13) The image processing device according to (12), in which

the segmentation section segments a plurality of the partial regions in parallel to one another.

(14) The image processing device according to (12), in which

the segmentation section segments a plurality of the partial regions sequentially.

(15) The image processing device according to (12), in which

the coding section codes a plurality of the partial regions in parallel to one another.

(16) The image processing device according to (12), in which

the coding section codes a plurality of the partial regions sequentially.

(17) An image processing method including:

segmenting a partial region at a position in response to a motion of a region of interest within an image to date from the image; and

coding an image of the partial area segmented from the image and generating coded data.

(18) An image processing device including:

an extraction section that extracts, from coded data that contains region-of-interest separation information for separating a region of interest from an image, the region-of-interest separation information;

a decoding section that decodes the coded data and that generates the image; and

a separation section that separates the region of interest from the image generated by the decoding section on the basis of the region-of-interest separation information extracted by the extraction section.

(19) The image processing device according to (18), in which

the region-of-interest separation information contains information indicating a shape and a size of the region of interest and a position of the region of interest in the partial region.

(20) An image processing method including:

extracting, from coded data that contains region-of-interest separation information for separating a region of interest from an image, the region-of-interest separation information;

decoding the coded data and generating the image; and

separating the region of interest from the generated image on the basis of the extracted region-of-interest separation information.

### REFERENCE SIGNS LIST

100 Image coding device, 101 Control section, 102 Processing section, 111 Image data input section, 112 Input image buffer, 113 ROI tracking and detection section, 114 Segmented region setting section, 115 Segmentation section, 116 Image coding section, 117 Coded data output section, 211 ME section, 212 ROI motion estimation vector generation section, 311 ROI separation information generation section, 312 Metadata addition section, 350 image decoding device, 351 Control section, 352 Processing section, 361 Coded data input section, 362 Metadata separation section, 363 ROI separation information buffer, 364 Image decoding section, 365 ROI image separation section, 366 Image data output section, 400 Image coding device, 401 Control section, 402 Processing section, 411 Image data input section, 412 Image coding section, 413 Multiplexing section, 414 Multiplexed data output section, 421 Image coding section, 450 Image coding device, 451 Control section, 452 Processing section, 461 Image data input section, 462 Input image buffer, 463 image coding section, 464 Segmented image coded data buffer, 465 Multiplexing section, 466 Multiplexed data output section, 500 Image decoding device, 501 Control section, 502 Processing section, 511 Multiplexed data input section, 512 Multiplexed separation section, 513 Image decoding section, 514 Segmented image data output section, 521 Image decoding section, 550 Image decoding device, 551 Control section, 552 Processing section, 561 Multiplexed data input section, 562 Multiplexed separation section, 563 Segmented image coded data buffer, 564 Image decoding section, 565 Segmented image buffer, 566 Segmented image data output section, 0J Computer

1. An image processing device comprising:
a segmentation section that segments a partial region at a position in response to a motion of a region of interest within an image to date from the image; and
a coding section that codes an image of the partial region segmented from the image by the segmentation section, and that generates coded data.

2. The image processing device according to claim 1, wherein
the segmentation section sets, as a central position of the partial region, a position moved from a central position of the current region of interest in a same direction by a same distance as a direction and a distance of the motion of the region of interest to date.

3. The image processing device according to claim 2, wherein
the segmentation section adds a predetermined pixel value to a part of the partial region located outside of a frame of the image.

4. The image processing device according to claim 1, wherein
in a case of setting, as a central position of the partial region, a position moved from a central position of the current region of interest in a same direction by a same distance as a direction and a distance of the motion of the region of interest to date and the partial region does not contain the region of interest, the segmentation section sets, as the central position of the partial region, a position moved from the central position of the current region of interest in the same direction as the direction of the motion of the region of interest to date by a maximum distance in a range in which the partial region contains the region of interest.

5. The image processing device according to claim 1, wherein
in a case of setting, as a central position of the partial region, a position moved from a central position of the current region of interest in a same direction by a same distance as a direction and a distance of the motion of the region of interest to date and the partial region does not contain the region of interest, the segmentation section sets, as the central position of the partial region, a position moved from the central position of the current region of interest in the same direction as the direction of the motion of the region of interest to date by a maximum distance in a range in which the image contains the partial region.

6. The image processing device according to claim 1, wherein
the segmentation section segments the partial region with a position in response to the motion of the region of interest to date obtained by tracking and detecting the region of interest set as a central position of the partial region.

7. The image processing device according to claim 1, wherein
the segmentation section segments the partial region with a position in response to the motion of the region of interest to date obtained by motion prediction of an image of the partial region by the coding section as a central position of the partial region.

8. The image processing device according to claim 1, wherein
the segmentation section segments the partial region at a preset shape and a preset size.

9. The image processing device according to claim 1, wherein
the segmentation section segments the partial region at a shape and a size in response to a shape and a size of the region of interest.

10. The image processing device according to claim 1, wherein
the coding section contains region-of-interest separation information for separating the region of interest from the partial region in the coded data.

11. The image processing device according to claim 10, wherein
the region-of-interest separation information contains information indicating a shape and a size of the region of interest and information indicating a position of the region of interest in the partial region.

12. The image processing device according to claim 1, wherein
the segmentation section segments the partial regions corresponding to a plurality of the regions of interest, respectively, and
the coding section codes a plurality of the partial regions segmented by the segmentation section.

13. The image processing device according to claim 12, wherein
the segmentation section segments a plurality of the partial regions in parallel to one another.

14. The image processing device according to claim 12, wherein
the segmentation section segments a plurality of the partial regions sequentially.

15. The image processing device according to claim 12, wherein
the coding section codes a plurality of the partial regions in parallel to one another.

16. The image processing device according to claim 12, wherein
the coding section codes a plurality of the partial regions sequentially.

17. An image processing method comprising:
segmenting a partial region at a position in response to a motion of a region of interest within an image to date from the image; and
coding an image of the partial area segmented from the image and generating coded data.

18. An image processing device comprising:
an extraction section that extracts, from coded data that contains region-of-interest separation information for separating a region of interest from an image, the region-of-interest separation information;
a decoding section that decodes the coded data and that generates the image; and
a separation section that separates the region of interest from the image generated by the decoding section on a basis of the region-of-interest separation information extracted by the extraction section.

19. The image processing device according to claim 18, wherein
the region-of-interest separation information contains information indicating a shape and a size of the region of interest and a position of the region of interest in the partial region.

20. An image processing method comprising:
extracting, from coded data that contains region-of-interest separation information for separating a region of interest from an image, the region-of-interest separation information;
decoding the coded data and generating the image; and
separating the region of interest from the generated image on a basis of the extracted region-of-interest separation information.
